(19) United States
(12) Patent Application Publication
(10) Pub. No.: US 2007/0244900 A1
(43) Pub. Date: Oct. 18, 2007

(54) Internet-based search system and method of use

(76) Inventors: Kevin Hopkins, Sandy, UT (US); Jeff Budge, Sandy, UT (US)

Correspondence Address: Brent T. Winder;Jones Waldo Holbrook & McDonough, PC, Suite 1500, 170 South Main Street, Salt Lake City, UT, 84101-1644, US

(21) Appl. No.: 11/359,801

(22) Filed: Feb. 22, 2006

Related U.S. Application Data
(60) Provisional application No. 60/655,179, filed on Feb. 22, 2005.

(51) Int. Cl. G06F 17/30

(52) U.S. Cl. 707/10

(57) ABSTRACT

An Internet-based search system and method of use. The system in its various embodiments includes an electronic database. The database includes one or more topical categories of information and wherein the categories are further divided into datasets of one or more pre-selected web locations. The invention also includes an Internet remote in communication with the database. The Internet remote includes in its various embodiments, a title bar, one or more advertising windows, a channel selector, a navigation palette, a navigation panel, and an optional set of additional links. In operation, a user selects a channel from the channel selector, which then causes the display of one or more categories in the navigation palette. Upon selection of the desired category, one or more subcategory bars appear in the navigation panel, the selection of which causes the display of one or more links to either a website, or a particular page within a website. Alternatively, the user may enter a search term and, upon selection of a web site, that search term is passed to the selected site employing its own search function. In either circumstance, when the user selects a link, that link displays in a separate companion web browser such that both the remote and companion browser are simultaneously viewable.

### PRIORITY

This application claims priority to U.S. provisional patent application no. 60/655,179, filed February 22, 2005, and hereby incorporates by reference the application for its supporting teachings.

### BACKGROUND OF THE INVENTION

The Internet search community currently has an almost unified focus on a single search methodology. Traditional Internet search engines like Google, Yahoo!, and others employ a searching process known as “keyword-based search,” so called because these search engines seek primarily to locate web sites whose titles, descriptions (“tags”), and textual content contain large numbers of relevant references to the search keyword that the user has entered into the search engine. As these traditional search companies work to improve the quality of web search results, the vast majority of their research and development appears to be focused on initiatives that largely reinforce this traditional approach to search by:
Expanding the number of sites searched—search engines frequently jockey for bragging rights by claiming that they search literally billions of web sites.
Digging deeper into the “hidden web” by securing access to web sites and databases that cannot be reached by automated “web-crawlers.”
Fine-tuning search algorithms so that they can more efficiently find web sites related to the keyword search term.

These are all useful initiatives, and the search capabilities of traditional search engines continue to improve. However, as productive as the traditional approach to web search has been, it nevertheless suffers from a number of hidden and little recognized flaws that inherently prevent the traditional search model from addressing the full range of web users' potential needs. Before delineating these flaws, it is important to spell out what traditional search engines do well:
Finding named sites. Enter a company, store, or web site name into a traditional search engine, and one of the first results usually will be that particular company's web site. However, the follow-on results often will be random and many of them will be relatively meaningless. For instance, enter “Nordstrom” into a traditional search engine and the first result in one typical recent search was indeed Nordstrom.com. Among the remaining first-page results were three more or less random interior pages on this domain (careers, shoes, and Nordstrom Rack locations), three random news articles, two links from Amazon (one from its apparel shopping site and another to a book on Nordstrom), and one to the personal page of an unrelated computing professor named Nordstrom at a Swedish University.
Finding specific pieces of data. Enter a quotation, like a snippet from a poem or song lyric, or a well-delineated information request, and traditional search engines usually will find it. For instance, enter “World Series winner 1954,” and in one typical recent search five of the top ten results (including the top two) were credible, non-personal sites include the desired answer: the New York Giants. Again, however, these useful first-page results were polluted by a low-quality personal site (the third result), and links that referred to the Little League World Series and the Caribbean World Series.
Finding a few top sites within a category. Enter a broader (categorical) search term, and traditional search engines usually will identify at least a few sites that are among the most credible sites in that category. For instance, enter “women's shoes,” and in one typical recent search the first-page results included several top online and land-based shoe retailers (Payless, Footsmart, Online Shoes, Shoes.com, and Zappos), one specialty shoe-seller (Designer Shoes), one general apparel retailer that sells shoes (Urban Outfitters), and two shopping search engines that reference shoes (PriceGrabber and NexTag). These are all appropriate results. However, they hardly constitute the principal top-of-mind responses when a typical shopper thinks about where to buy shoes. For instance, missing from these top results were such stores as Nordstrom, Macy's, and Target, among the nation's leading shoe sellers (in this particular search, Macy's appeared on the third page of results and Nordstrom on the fourth), as well as such prominent brand names as Skechers, Florsheim, Steve Madden, and Allen Edmonds.
Finding background information on specific topics. One of the most common web search needs is to find background information about a given topic—an information request that is more general than searching for a specific piece of data (like a particular World Series winner) but that is usually not sufficiently broad to warrant its own class of individual sites or even site subsections. For this type of search, traditional search engines also deliver some useful results, but their performance tends to be erratic. Consider, for instance, a typical recent search on the space phenomenon “black holes” (collapsed, high-gravity stars). Before searching, one might expect to find references to encyclopedia articles, articles from science sites or journals, or information from NASA. However, in searching for this term, the first-page results in this recent search contained only two such links, one to a second-tier science-oriented online almanac called “How Stuff Works” and one to a tangential NASA page (a virtual trip to a black hole). The other links were mostly to obscure university pages (some of which contained information that might be useful, but that was of uncertain credibility and limited familiarity). Not until the bottom of the sixth results page did a reference to a highly credible encyclopedia or review article appear (in addition, the About.com black holes page and the Wikipedia article on black holes appeared on search results pages 3 and 4, respectively).

Beyond this mix of capabilities and shortcomings, the traditional search model also suffers from some rather more serious endemic flaws. Some of these flaws are obvious to anyone who has spent any time searching on the web, such as the pollution of otherwise credible search results with irrelevant, low-quality, or tangential web sites, and the spawning of long lists of difficult-to-scan results through which users must tediously search for the information they are seeking. At least in theory, more sophisticated search algorithms might lead to more precise search results in this respect. However, most of the flaws in the traditional search model are not particularly amenable to improvement from algorithmic fine-tuning. Specifically:
The omission of credible sites. Even in cases in which a search (particularly a categorical or background information search) yields some top-quality sites, many major sites are omitted. In fact, even in the best circumstances, some 90% to 95% of credible sites or links in a given category are typically missing from the first three to five pages of search results from conventional search engines. This is not a significant problem in instances in which web users are looking for specific pieces of information (e.g., a typical user will need only one or two sites to discover and validate who won the World Series in 1954), but it may be a problem for users who are conducting more general or less well-defined searches or who are interested in comparing or aggregating information or products across a large number of sites.
The inability to search by category. Traditional search engines typically index web sites based on some combination of site title and tags, site popularity, and keyword density (i.e., the frequency with which the keyword is mentioned in the site's textual content). These indexing practices are content-specific, in that they rely primarily on the literal usage of words in site titles, tags, or text. Because of the current limits of artificial intelligence, it remains exceedingly difficult for search engines to identify and hence index sites according to their conceptual nature—what these sites are “about” rather than the words they contain. As a consequence, even in cases in which credible search results are reported, usually only a minority of these results are categorical in nature. For instance, in the black holes search described above, just four sites within the first six pages were both credible and categorical (i.e., overview) sites. Others were either tangential to the main subject, or else (more commonly) point-in-time news stories that referenced black holes but were not general information resources and not even necessarily “about” black holes. Conceptual shortcomings like this make it virtually impossible for conventional search engines to produce a relatively unpolluted list of categorical search results (e.g., a list of overview or encyclopedia articles on black holes).
The inability to browse. This lack of categorical-search capability makes it impossible for users to quickly browse through all of the relevant and credible sites within a given category or covering a given topic or else among stores or store departments selling a particular product. But this is not the only barrier to the easy scanning of sites. Conventional search results pages typically devote most of their real estate to supposedly descriptive information about a web site or link that, in fact, may not be relevant to the search nor even particularly useful in evaluating the worth of the indicated link. For instance, the first result reported in a recent search for “black holes” was: “Black Holes Cambridge Relativity: Black Holes. BLACK HOLES. Introduction to black holes.
Observational evidence for black holes. Black holes and critical phenomena. www.damtp.cam.ac.uk/user/gr/public/bh_home.html—2 k—Dec. 4, 2004—Cached—Similar pages”

The only even marginally credentialing information in this lengthy description is the merely partly stated: “Cambridge (University).” The rest is of little probative value. And yet the pervasive inclusion of this often meaningless information in traditional search engines' results not only forces users to scroll though long lists and multiple pages in order to locate their desired information, but it also tends to bury the most useful credentialing information amidst the less useful. This is not a significant problem if users are searching for a specific piece of data (e.g., World Series winners), but it makes more general categorical searches highly inefficient.

Beyond these basic problems with the traditional search model, search algorithms themselves—no matter how well refined they might become—are inherently flawed in several key respects. While ever-more-precise search algorithms are useful tools for identifying specific pieces of information, and may aid in identifying a few credible and relevant categorical or topical sites, they intrinsically fail to optimize categorically oriented search results for the following reasons:
The shortcomings of strict prioritization. Many traditional search engines and web directories attempt to aid users in finding information by strictly prioritizing site listings according to a credible measure of “bestness,” relevance, or popularity. Such efforts are useful to a degree. Yet they suffer in three key respects: (1) most such prioritized lists and directories still typically omit more than 90% of credible sites or links in the most easily visible results in the various search categories; (2) they still include a significant proportion of irrelevant or low-quality sites, even within the first three pages of results, and often ranked ahead of obviously more credible sites; and, most importantly, (3) they (falsely) assume that there is an objective or generally applicable “bestness” or “relevance” criterion that can be used to rank the sites in some sort of logical order. There clearly is a reasonable case for distinguishing sites according to whether they are credible or not. But the case for a strictly ordered listing is tenuous indeed. Is CNN a better news source than Fox News or the New York Times? Is Macy's a better store than Nordstrom or Kmart? And so on. Of course, in practice this is largely an academic question anyway, since most search engine results are so polluted with obviously bad results that the idea of rank-ordering is largely a fiction. Still, the key point remains: even if search algorithms could weed out all of the “bad” sites, there would be no objective basis for rank-ordering the remaining “good” sites.
The situational nature of “bestness.” Another flaw in the strict prioritization approach is the assumption that there is a single measure of “bestness” for all times and all situations. That is, even if “bestness” were a valid concept, the assumption in most search engine algorithms is that this criterion is uniformly applicable in all situations and for all web searchers. In fact, “bestness” is largely context-dependent, determined by an array of often unstated situational variables that no conventional search engine captures. Consider, for instance, the question: “Where is the best place to buy shoes?”If one is a style-conscious adult female shopper, a good answer might be Nordstrom. If one is a brand-conscious adult male shopper, a good answer might be Allen Edmonds. If one is a teenage girl, a good answer might be Steve Madden. If one is a moderate-income mother with six children, a good answer might be Payless or Target. If one is a lowest-price searcher of any income range, a good answer might be a price comparison site like Shopping.com. In short, there is simply no one “best” answer—nor even one best group of answers—to such search inquiries. Rather, there are probably at least 100 to 150 highly credible retail entities on the web where at least thousands of people buy shoes every month. There is simply no way for a conventional search engine to know who is searching or why, and so any attempt to parse these credible sites for the “best” ones is doomed to fail.
The human factor in search. The situational nature of search thus makes it impossible for a standard search engine to provide personally relevant search results to each individual searcher without requiring them to answer a series of highly intrusive questions that most web searchers would not tolerate (e.g., “Are you male or female?” “What is your age?” “What is your most important criterion for buying shoes?” etc.). More than mere situational variability, however, people's desires change over time—often from week to week or day to day. Even elaborately personalized search engines cannot capture these changes. For instance, if one is a teenage girl building her shoe collection in August in preparation for school, she may prefer Steve Madden; if she is shopping for her mother at Christmastime, she may prefer Nordstrom; if she is searching for shoes for the end-of-school prom, she may prefer a formalwear shop; and so on. And such timing considerations exclude even more individualistic weighting factors, like good or bad shopping experiences one may have had with a particular store, influencing factors of which even the individuals in question may not be consciously aware. Because of these inaccessible preference variables, the only way for a search engine to meet the needs of the majority of web searchers is to present them with a list of all reasonably credible sites within the larger, categorical domain (e.g., all credible shoe sellers), and let the users themselves choose among those sites or stores according to their particular preferences at that given time—something that no major search engine does today but something that shoppers and searchers do every time they enter a shopping mall, scan the Sunday newspaper ads, browse a magazine stand, read the daily TV schedule, or visit a library or book store.
The need for intelligent limits. This ability to browse through the most credible web sites in any given category assumes that users are facing a roster of no more than a few score sites rather than a few thousand or, more commonly on most conventional search engines, millions of sites. Keyword-based searches restricted to these top-quality, credible sites will produce a manageable number of very high-quality, highly relevant search results. By contrast, even with the best search algorithms, searching among literally billions of web sites as most conventional search engines do for any given search inevitably will produce thousands if not millions of results (search Google for “women's shoes,” for instance, and you receive 19.6 million results), most of which will be irrelevant or of low-quality. Such a comprehensive search is useful if someone is trying to locate information about an old friend or an esoteric research topic, but typically does more harm than good for the majority of more conventional or broad-based searches. In that case, intelligently restricted searches, rather than searches among all conceivable web sites, will be optimal.
The need for predictability. Familiarity and context are exceedingly important factors in any type search. Imagine, for example, how disorienting it would be if the location of the stores in one's favorite shopping mall changed every time one visited, with stores unpredictably appearing or vanishing on each foray. Or imagine how frustrating it would be if the neighborhood grocery totally rearranged the merchandise on its shelves every week: a shopping trip that normally would take an hour could consume an entire afternoon. And yet this constant change is the principle that governs the traditional web search model: the search results are almost never the same. Hence, not only are the majority of credible sites omitted from typical search results, but what is included and what is excluded—and the order in which they are presented—varies from day to day, sometimes from hour to hour. Paid-search sites and most shopping comparison sites only worsen these problems because they usually include only those sites that pay for inclusion or position. Socially ranked search, like that being pursued by Yahoo!, suffers from the same flaw, because its purpose is to change rather than preserve search order according to social preferences.

Thus, despite the apparent conventional wisdom that Internet search is on the right course and only needs to be fine-tuned, in fact the conventional Internet search model is deeply flawed. Not only are these flaws present, but they are intrinsic to the model itself, and most will not be eliminated regardless of how refined, precise, and intelligent the search algorithms become.

The present invention in its various embodiments solves each of the foregoing problems, as well as others.

### ADVANTAGES AND FEATURES OF THE INVENTION IN ITS VARIOUS EMBODIMENTS

Certain advantages and features of the present invention in its various embodiments include, but are not limited to the following:
1) Improved content display. As will be discussed further below, the present system is capable of segmenting search navigation and the referenced content into two independent but linked web browsers. Specifically, navigation and search results are contained in an Internet remote control device (“the Internet Remote”), and web pages can be simultaneously displayed in a larger “target” browser window (the “companion browser”). Because the Internet Remote—unlike traditional search engine navigation—is persistently viewable throughout the site-browsing process, the effect of using the present system in its various embodiments is very similar to using a television remote to browse among network and cable TV channels.
2) Enhanced search results. The present system in its various embodiments is capable of providing significantly enhanced search results for a majority of categorical and common keyword searches. Categorical search results can be delivered through thousands of pre-built, human-edited datasets that can feature as many as 90% or more of the most credible sites within each category while excluding irrelevant or low-quality sites—dramatically enhancing the quality of categorical search results. To improve readability, these results can be presented in a few logical subcategories and, within these, organized in easy-to-scan alphabetical order. In addition, only site names—no lengthy descriptions—can be presented, making it possible to display hundreds of results in less space than most search engines are able to present fewer than a dozen. For keyword-based searches, the system can include large numbers of multiple aliases in its keyword indexes, enabling users to navigate immediately to their category of interest. Thus, the search domain can be restricted to only those sites most likely to contain the results a user is seeking—thereby improving both the quality and efficiency of the search.
3) Superior presentation technology. The present system in its various embodiments is compatible with, and indeed in some embodiments, fully embraces, AJAX (asynchronous JavaScript and XML) technology. By incorporating AJAX, the present system is able to present thousands of content modules that once would have required hundreds of separate web pages within a single, small-footprint web application—one that nevertheless functions as quickly and efficiently as installed desktop software. Yet unlike desktop software, not to mention early-vintage web navigation tools and contemporary browser toolbars, the present system is able to avoid long and potentially system-crashing downloads, it requires no user installation, and no special browser plug-ins. It is simply a web page—albeit a highly efficient, AJAX-enabled web page.
4) Ease of Use. The present invention, in its various embodiments, can include an application-wide alphabetical index—an “index of the Internet”—with embedded meta-categories (larger, logical groupings of categories) and multiple synonyms and alternative topic names that makes it easy for users to scan and find the specific information categories for which they are searching.

Another advantage of the present system is its ability to display and present advertising and promotional materials. The system, in its various embodiments, creates an exceptionally compelling advertising environment for both brand-name and high-quality specialty sites and stores because the application preserves the targeting and timing advantages of conventional keyword ads while enhancing the ads' appeal to both users and advertisers, in a number of important respects—including, but not limited to the following:
A premium-quality environment. By virtue of its own high quality search capabilities, the present invention in its various embodiments is able to maintain a premium, brand-focused search environment that can be as inviting to high-quality sites and stores as is an upscale shopping mall or a high-end magazine.
An incentive to buy. The uniformly high quality of the sites and stores that can be included within the present system makes for a highly inviting search, browsing, and shopping environment for users as well, significantly increasing the likelihood that they will spend time on the site and feel comfortable purchasing from included sites or sponsors, further enhancing the site's appeal to potential advertisers. This “incentive to buy” is strengthened by the persistent view of most advertisements, as described below.
Enhanced keyword advertising. The present system in its various embodiments is also capable of selling advertising against any number of keywords, as other search engines do—thereby giving the same range of advertising potential that even the largest search engines boast. However, beyond this, the present system allows for keyword-style advertising for thousands of pre-built search categories, enabling advertisers to purchase ads for a single category rather than having to rely on the guesswork of buying dozens of individual keywords—and allowing these advertisers to capture the interest of consumers who may just be browsing rather than looking for a specific product. As will discussed in more detail below, these keyword ads can be displayed within the companion browser, or else directly within the Internet Remote. The advertisements can also contain a rollover-display feature that allows advertisers to present richer, more dynamic content than is achievable with conventional search engine keyword ads. In one embodiment, the present system includes a pay-per action (e.g., commission on sale) advertising model, which can help minimize the problem of click fraud. For example, in one embodiment, no advertiser payments are made unless a specific revenue-generating action is consummated.
A rich-media advertising environment. The Internet Remote contains a built-in video window that—for the first time—enables the presentation of keyword- and category-based video and multimedia advertising directly within the context of a search engine function. Designed as a cycling video display, the built-in video window can present serial streams of video advertisements, each of which can be clicked to open the advertiser's target web content in the Internet Remote's companion browser.
Full-page advertising. The present system, in its various embodiments, is also able to provide integrated, non-interruptive full-page advertising. In one embodiment, when a user enters a search term or selects a category within the Internet Remote, the content within the companion browser is, by default, left undefined. Therefore, a system operator can sell the right to advertisers to become the default web site shown within the companion browser when a keyword is entered or a category is selected. Alternatively, segments of the full-page so displayed can include, without limitation, a variety of advertisements, such as banner and display advertisements, video and animated advertisements, keyword-based advertisements, and Zip Code-based and other localized advertisements.
Persistent advertising display. One of the most significant shortcomings of current keyword-based advertising is that the ads disappear from view once the user has made a selection from the search results, negating the original value of the user impression. The same is true of display ads placed within content pages. However, because the Internet Remote can be persistently viewable during the entire search and browsing experience, both keyword ads and rich-media ads are either directly viewable or else are accessible with a single click—a persistence of advertising impression that no conventional search engine provides. Indeed, in one embodiment, video ads can be running the entire time a user is browsing through a category. Thus, the present system is the first search engine to offer the equivalent of the highly lucrative captive advertising found on television—except with no “commercial breaks,” since the ads run continuously throughout the user's browsing session. This is a significant advancement: for the first time, search-based advertisers can appeal to Internet users long after the users have begun exploring the search results.

To the extent it is not made clear above, the present invention, in its various embodiments, also improves upon keyword-based searches of the type employed by the traditional search engines. Specifically, the various embodiments of the invention allow users to conduct searches within individual data categories or groups of data categories, with the search “universe” constrained to only those sites listed within the referenced, pre-built categories. For instance, in searching for “Ecco loafers” in the invention's “Shoes” category, the search would be conducted only among the hundred or so high-quality shoe-selling web sites listed within that data category, rather than among the billions of web sites searched by traditional search engines. This process significantly improves the quality and relevance of search results, regardless of the particular keyword search algorithm that is used, because it limits the search universe to only those sits that are most likely to contain the information that users are seeking—and in the context in which they are seeking it.

### SUMMARY OF THE INVENTION

As detailed below, the invention in its various embodiments solves the set of problems described above, as well as others, through a number of innovations. The presently claimed invention is an Internet-based search system. The system in its various embodiments includes an electronic database. The database includes one or more topical categories of information and wherein the categories are further divided into datasets of one or more pre-selected web locations. The invention also includes an Internet remote in communication with the database. The Internet remote includes in its various embodiments, a title bar, one or more advertising windows, a channel selector, a navigation palette, a navigation panel, and an optional set of additional links. In operation, a user selects a channel from the channel selector, which then causes the display of one or more categories in the navigation palette. Upon selection of the desired category, one or more subcategory bars appear in the navigation panel, the selection of which causes the display of one or more links to either a website, or a particular page within a website. A companion browser that is capable of displaying a website or web page when the user activates the links is also a feature.

The presently claimed invention also includes a method for allowing a user to locate and display a desired website, or page within a website. First, one or more web locations are selected. These web locations are then topically categorized into an electronic database, wherein the categories are further divided into datasets. The user is then provided an Internet remote in communication with the database. The Internet remote includes a title bar; one or more advertising windows; a channel selector; a navigation palette; a navigation panel; and an optional set of additional links. In operation, the user selects a channel from the channel selector, which then causes the display of one or more categories in the navigation palette; upon selection of the desired category, one or more subcategory bars appear in the navigation panel, the selection of which causes the display of one or more links to either a website, or a particular page within a website; the activation of which causes the corresponding website, or page within a website to be displayed in a companion browser.

Claim is also made to the Internet remote itself. As noted above, the Internet remote in its presently claimed embodiment includes a title bar; one or more advertising windows; a channel selector; a navigation palette; a navigation panel; and an optional set of additional links.

### BRIEF DESCRIPTION OF THE PREFERRED EMBODIMENT(S)

The present invention is advantageous because it enables a user, among other things, to search the Internet categorically by providing a systematic topical categorization of a variety of useful information topics. Additionally, and as will be explained further below, the present invention can employ an electronic database of web sites that allows the user not only to search categorically, but also narrows traditional keyword-based searches within a given category to highly credible and relevant sites that have been pre-selected for their quality and relevance. In one embodiment, a user can be assisted in such searchers by an online, topic-specific “Internet Remote,” an independent and persistent web browser window that deposits the results of the user's site selections in a second, companion browser window. In another embodiment, elements of the invention can be formatted for efficient display and use on cellular phones, personal digital assistants (PDAs), and other handheld computerized and wireless devices that have web-browsing capability.

In order to describe the manner in which the above-recited and other advantages and features of the invention can be obtained, a more particular description of the invention briefly described above will be rendered by reference to specific embodiments thereof that are illustrated in the appended drawings. These drawings depict only typical embodiments of the invention and are not therefore to be considered to be limiting of its scope.

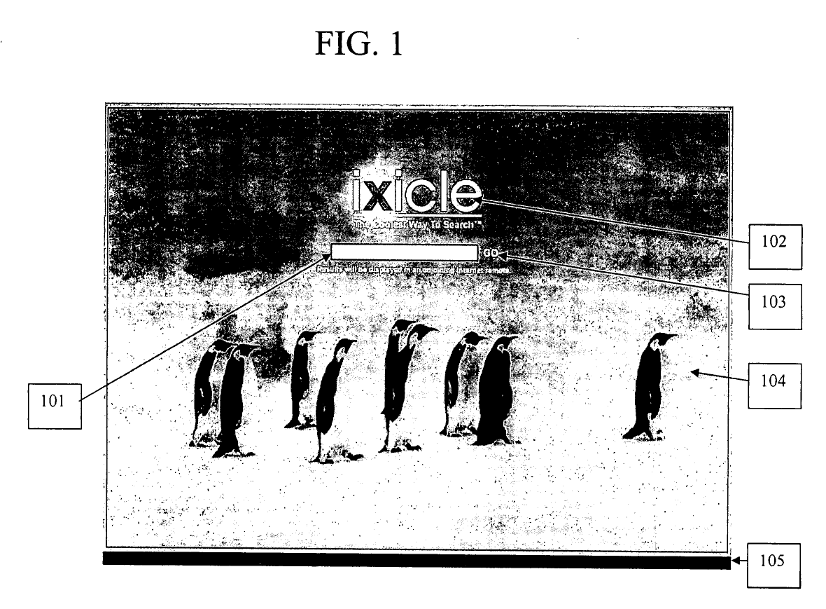

FIG. 1 is a home page of an Internet-based search system according to one embodiment of the present invention.

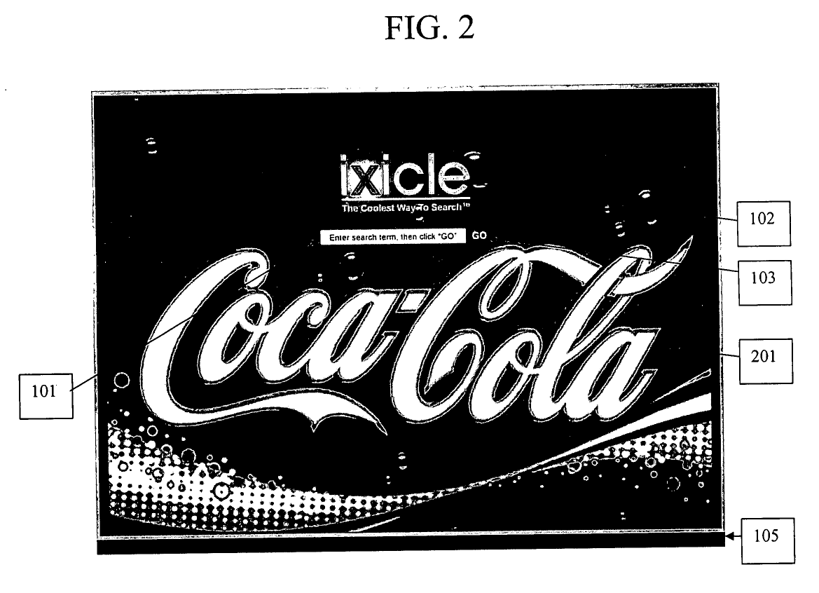

FIG. 2 is a home page of an Internet-based search system with a customized background image according to one embodiment of the present invention.

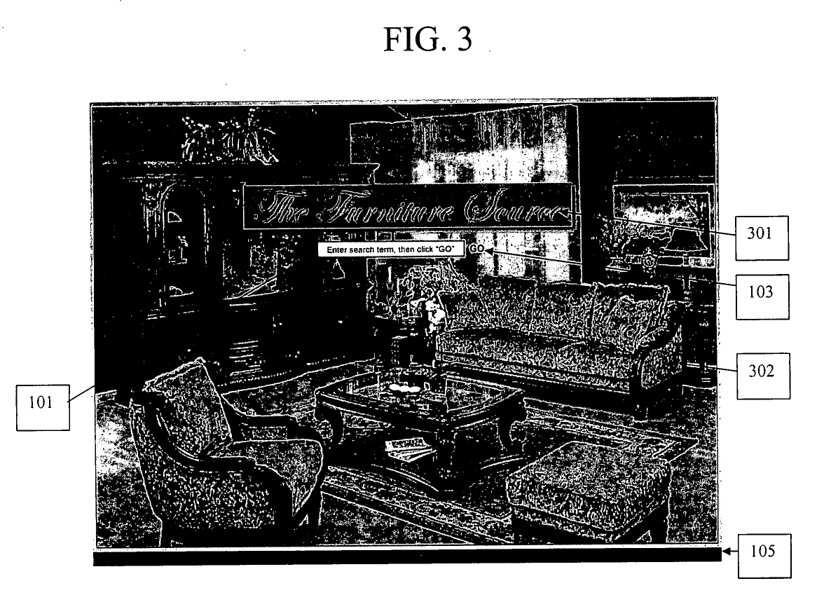

FIG. 3 is a home page of an Internet-based search system with a customized background image and logo according to one embodiment of the present invention.

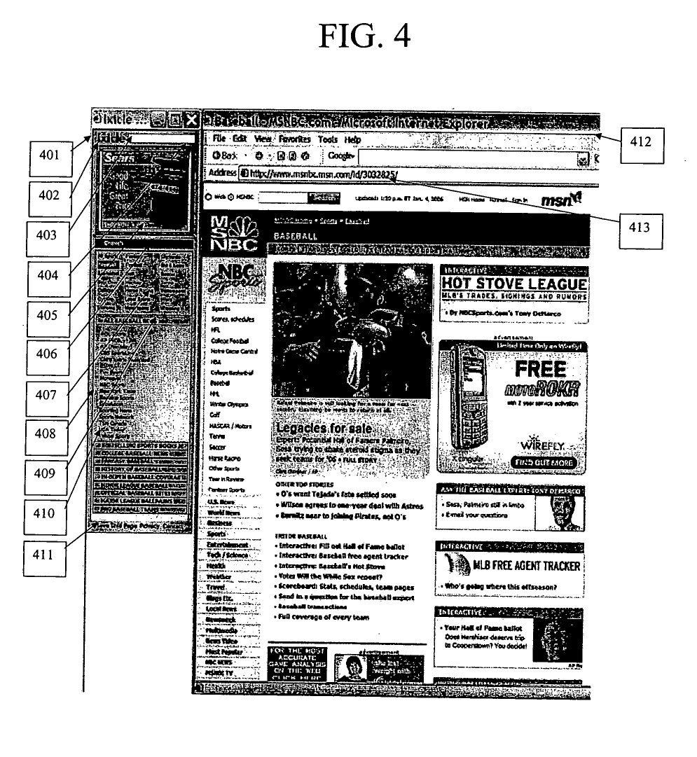

FIG. 4 depicts one embodiment of an “Internet Remote” and “companion browser” for an Internet-based search system according to one embodiment of the present invention.

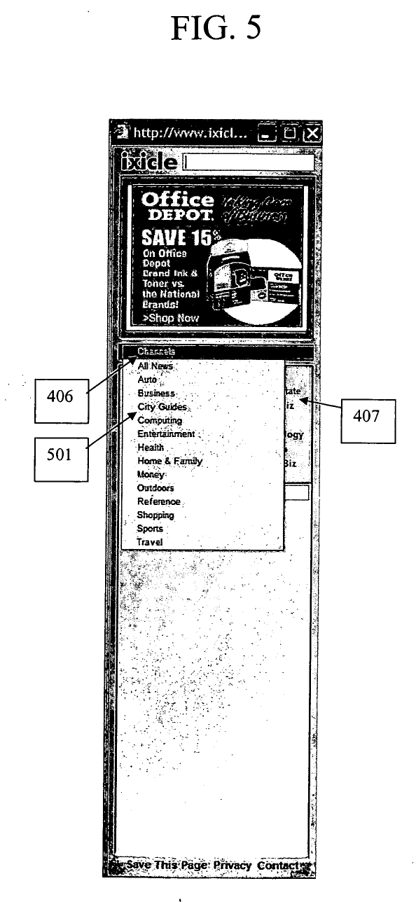

FIG. 5 depicts one embodiment of an “Internet Remote” for an Internet-based search system in which a user may choose among a variety of pre-defined channels of information, shopping products, travel destinations, or other content.

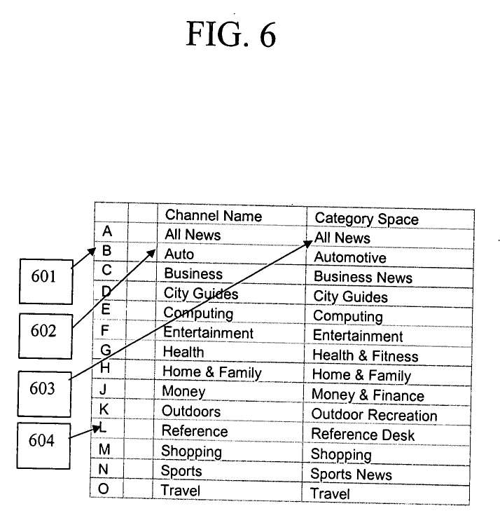

FIG. 6 is an illustrative example of one embodiment of a channel navigation system used for displaying content within an Internet Remote according to one embodiment of the present invention.

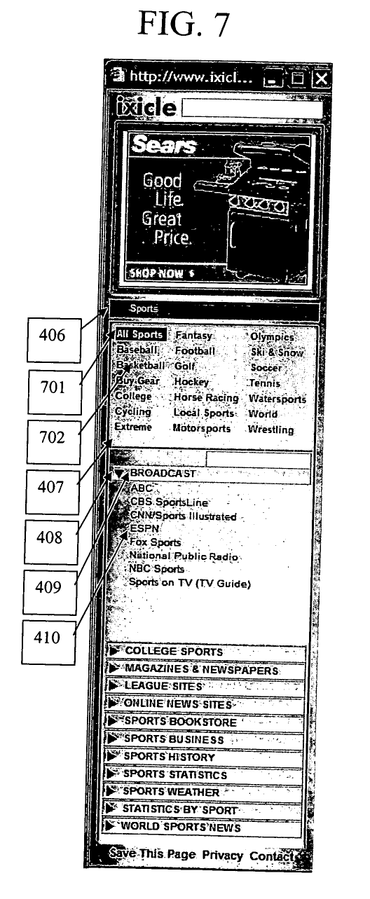

FIG. 7 depicts one embodiment of an “Internet Remote” for an Internet-based search system in which a user may choose among a variety of pre-defined sub-channels or categories of information within a given information channel.

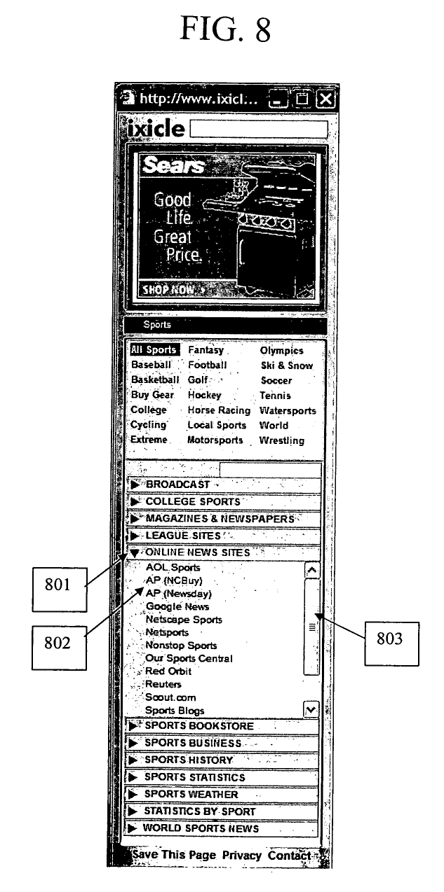

FIG. 8 depicts one embodiment of an Internet Remote for an Internet-based search system in which a user may use the sub-category navigation bars to view additional content according to one embodiment of the present invention.

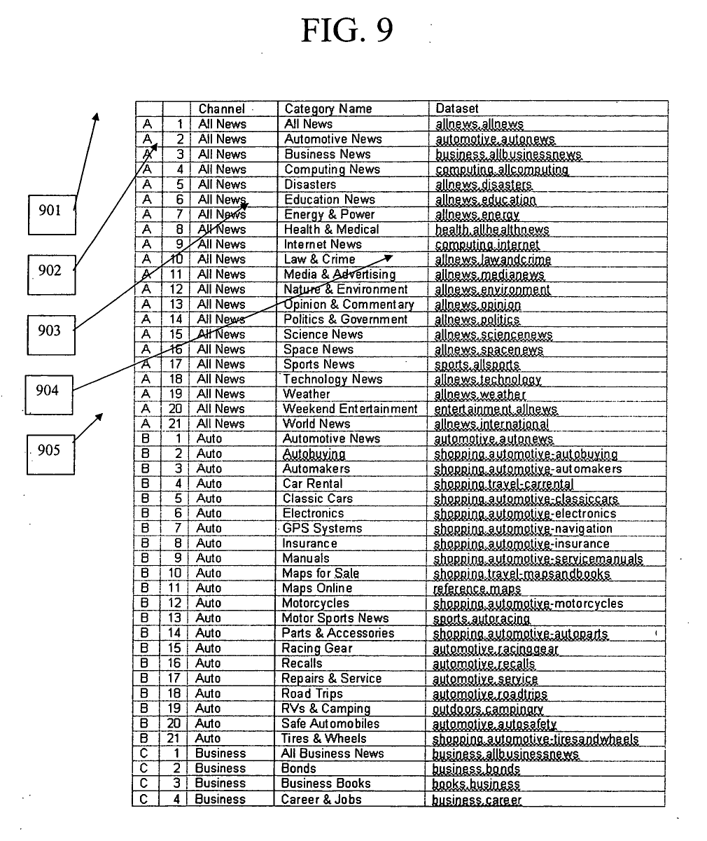

FIG. 9 is an illustrative example of one embodiment of a category structure used for displaying content within an Internet Remote according to one embodiment of the present invention.

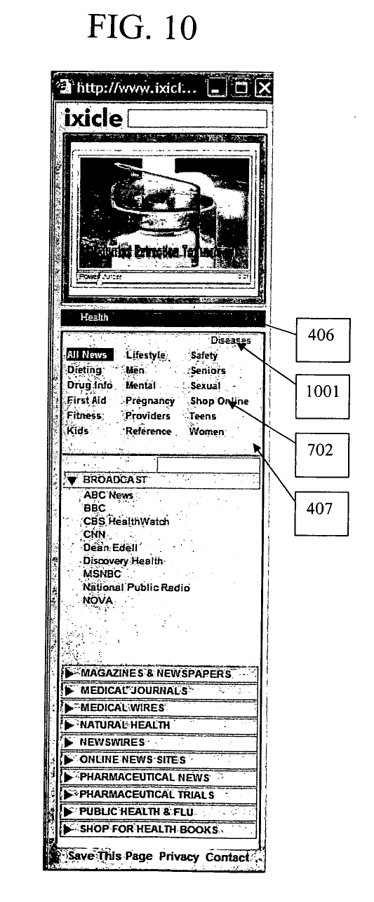

FIG. 10 depicts one embodiment of an Internet Remote for an Internet-based search system in which a user may choose among an extended number of pre-defined categories of information via an embedded list.

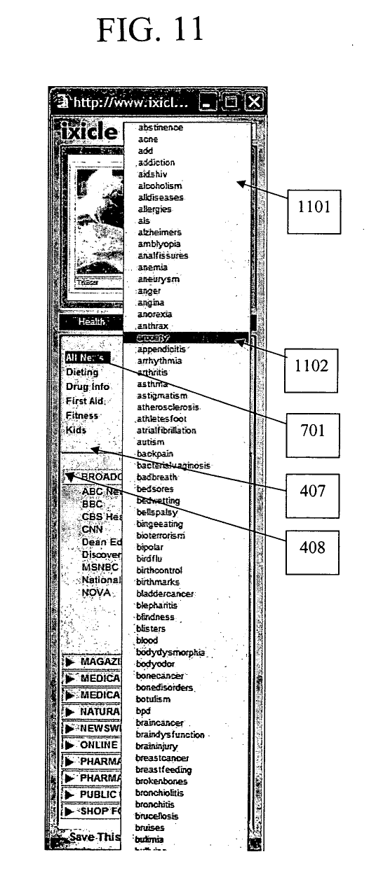

FIG. 11 depicts one embodiment of an Internet Remote for an Internet-based search system in which a user may choose among an extended number of pre-defined categories of information via an embedded list, now opened.

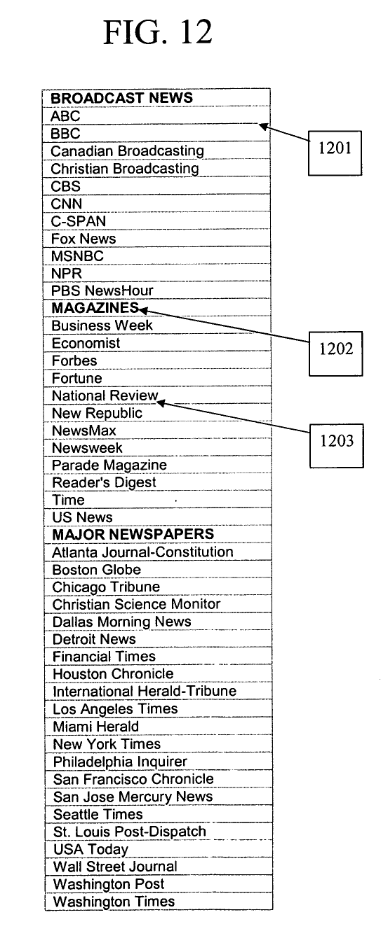

FIG. 12 is an illustrative example of an excerpt of a category-specific dataset as displayed in the navigation panel (Dataset Panel) of an Internet Remote for an Internet-based search system according to one embodiment of the present invention.

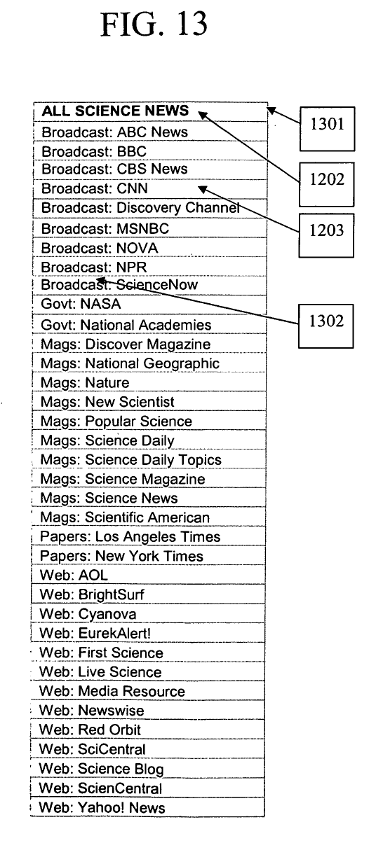

FIG. 13 is an illustrative example of an excerpt of a category-specific dataset as displayed in the navigation panel (Dataset Panel) of an Internet Remote for an Internet-based search system according to one embodiment of the present invention, in which the data is further subdivided into classes.

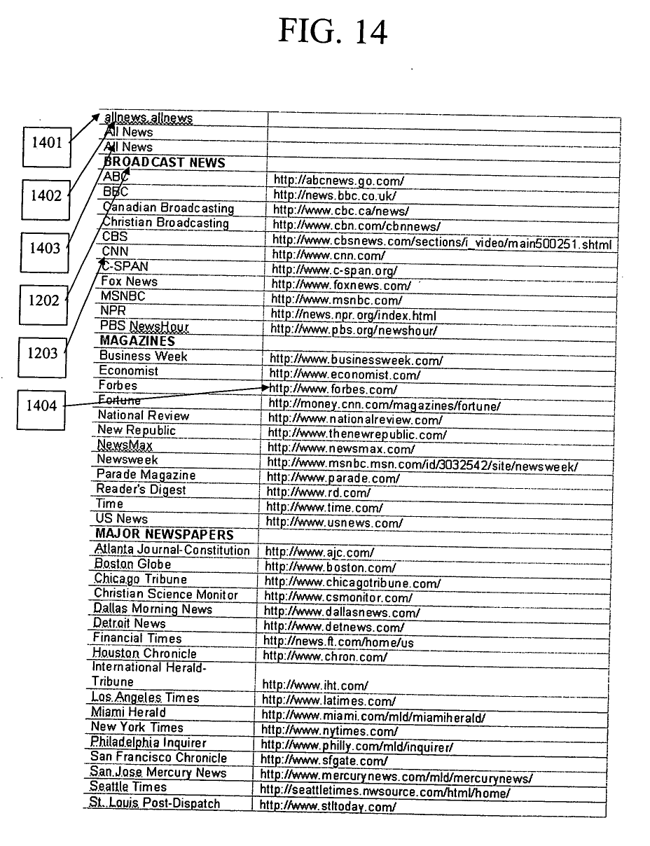

FIG. 14 is an illustrative example of an excerpt of the computer database underlying a Dataset component of an Internet-based search system according to one embodiment of the present invention.

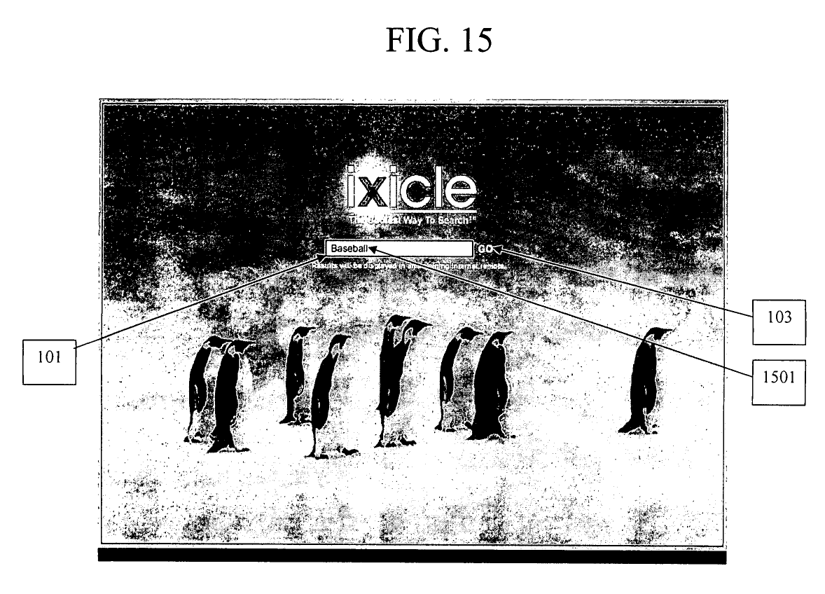

FIG. 15 depicts one embodiment of a home page of an Internet-based search system according to one embodiment of the present invention, in which a search term has been entered into a search box on the home page.

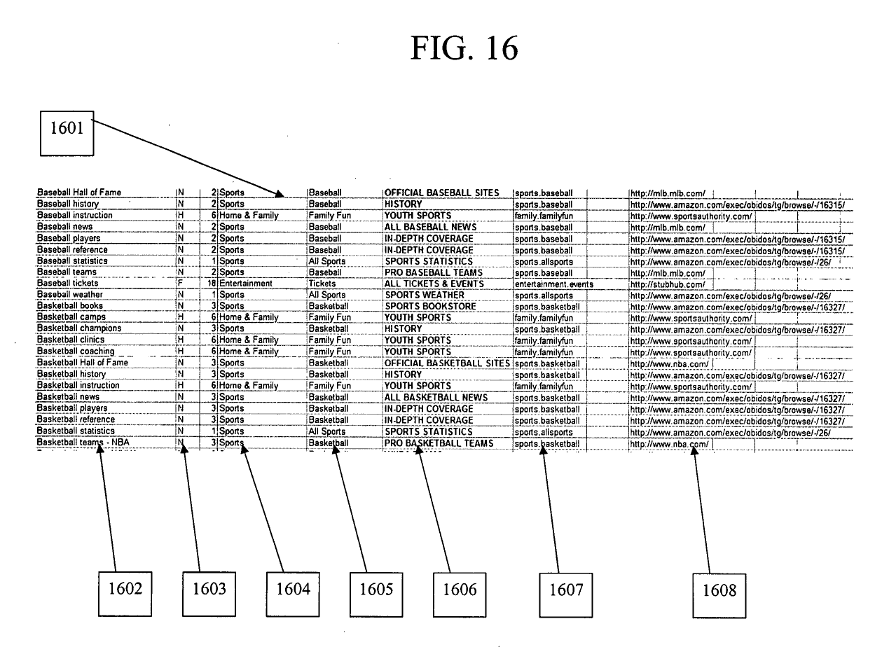

FIG. 16 depicts one embodiment of an excerpt of one of a collection of computer database indexes against which a search may be executed and the results displayed within an Internet Remote for an Internet-based search system according to one embodiment of the present invention.

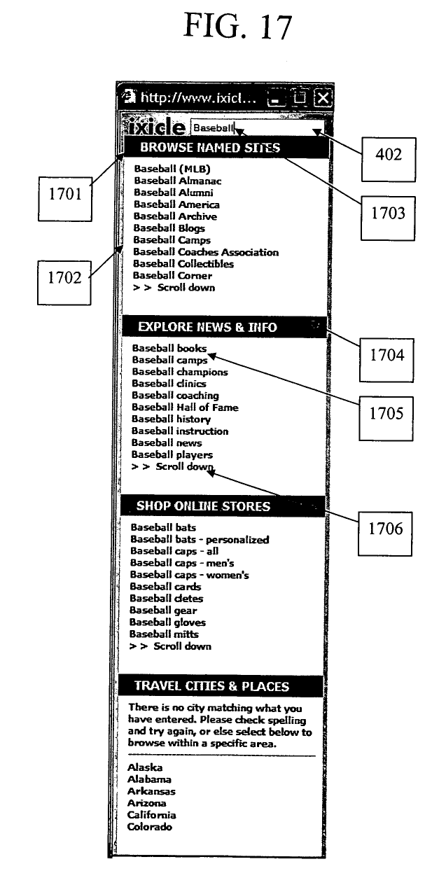

FIG. 17 depicts one embodiment of an Internet Remote for an Internet-based search system in which a search term has been passed from a search box on a home page or other page to the main search box of an Internet Remote for an Internet-based search system according to one embodiment of the present invention.

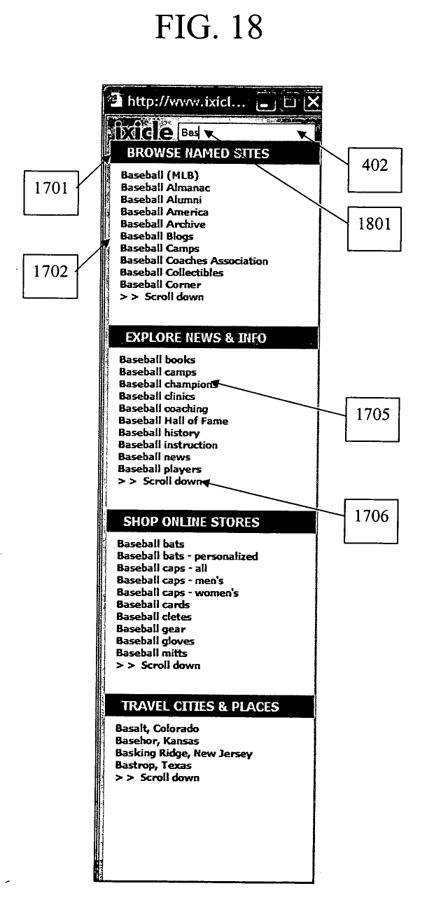

FIG. 18 depicts one embodiment of an Internet Remote in which a search term has been entered or modified within the main search box of an Internet Remote for an Internet-based search system according to one embodiment of the present invention.

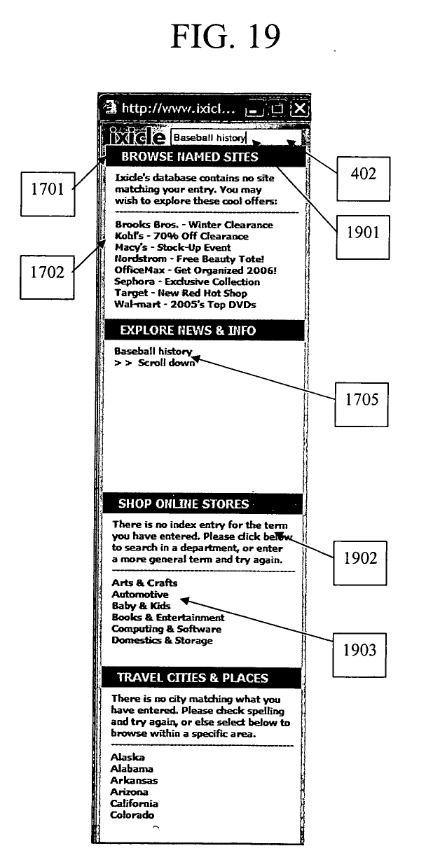

FIG. 19 depicts one embodiment of an Internet Remote for an Internet-based search system in which a search term has been refined more precisely within the main search box of an Internet Remote for an Internet-based search system according to one embodiment of the present invention.

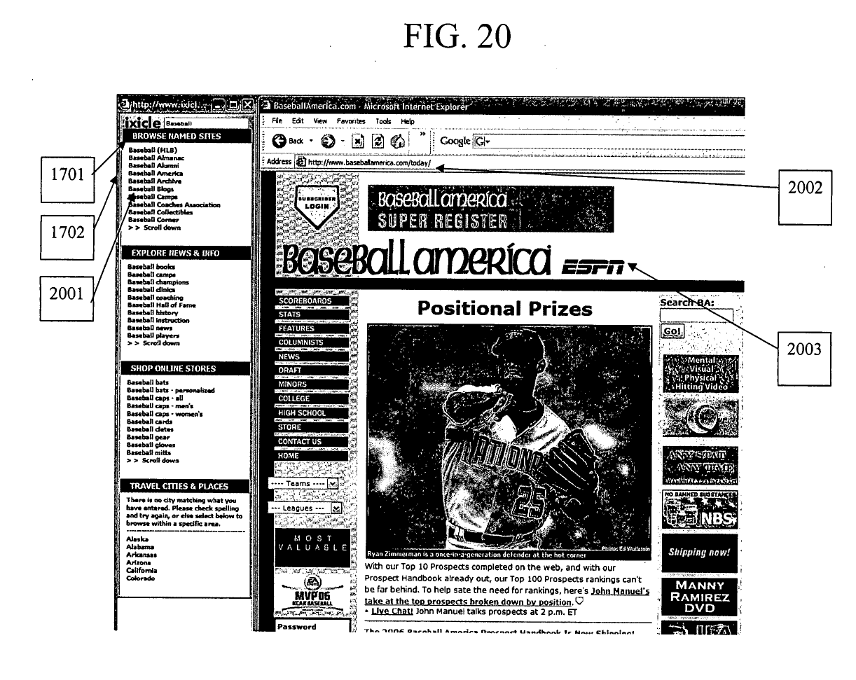

FIG. 20 depicts one embodiment of an Internet Remote and a companion browser for an Internet-based search system in which the user has selected a named site from the search results within an Internet Remote for an Internet-based search system according to one embodiment of the present invention.

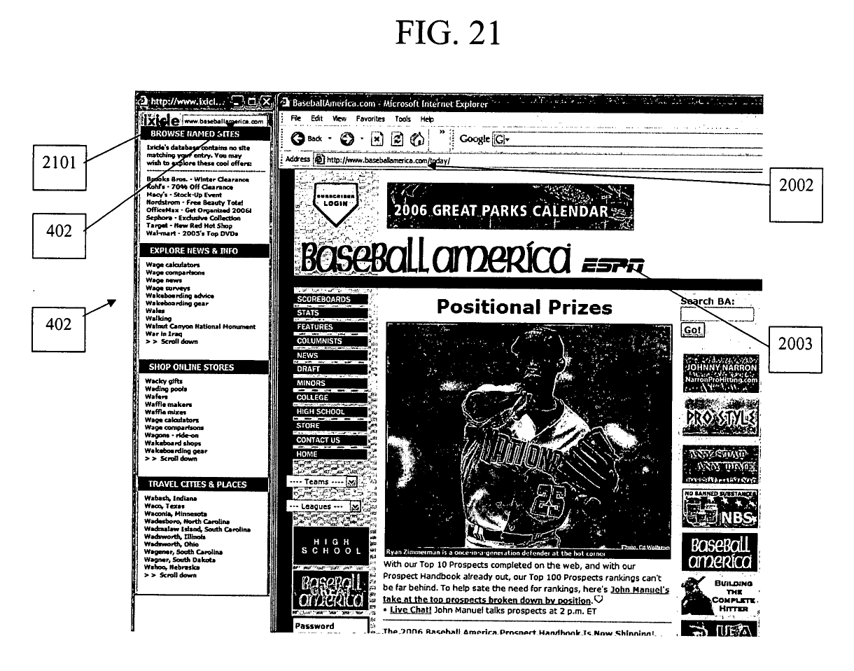

FIG. 21 depicts one embodiment of an Internet Remote and a companion browser for an Internet-based search system in which the user has entered a web site URL directly into the main search box of an Internet Remote for an Internet-based search system according to one embodiment of the present invention.

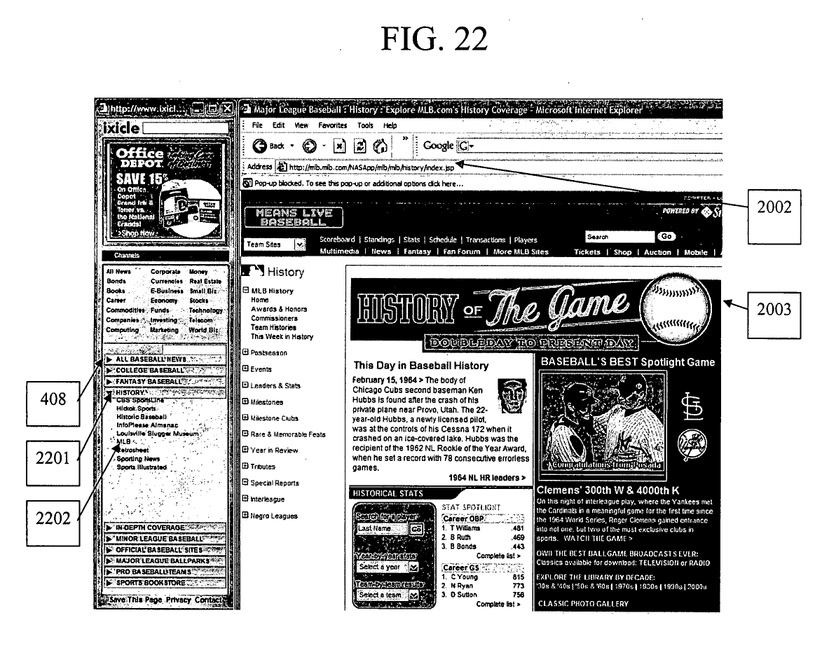

FIG. 22 depicts one embodiment of an Internet Remote and a companion browser for an Internet-based search system in which a category has been selected from the search results in an Internet Remote for an Internet-based search system according to one embodiment of the present invention.

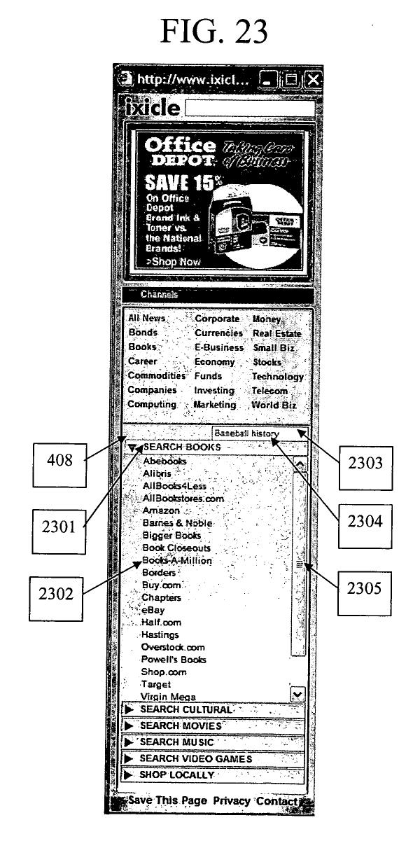

FIG. 23 depicts one embodiment of an Internet Remote for an Internet-based search system in which a search term has been passed to a pre-selected grouping of web sites in an Internet Remote for an Internet-based search system according to one embodiment of the present invention.

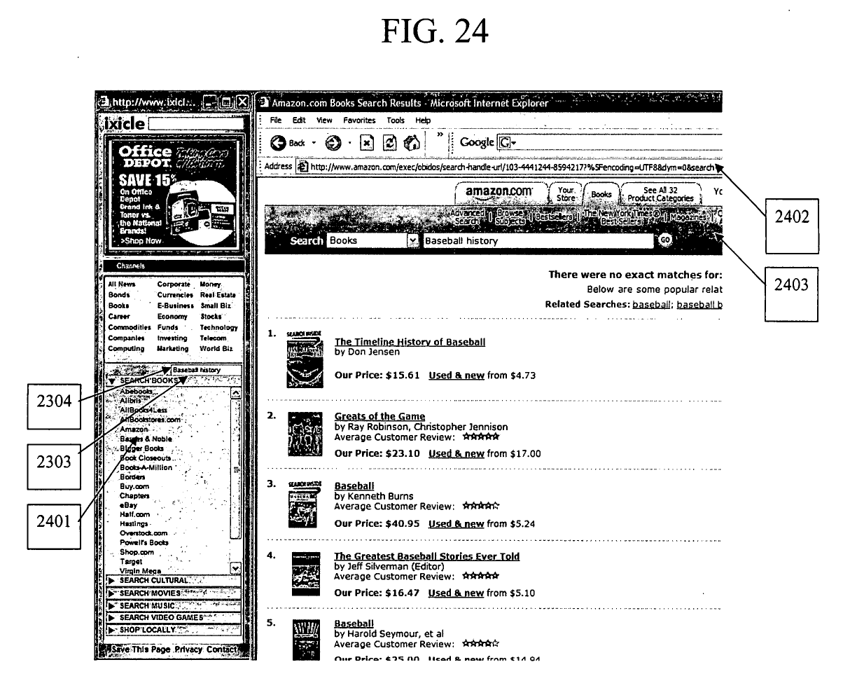

FIG. 24 depicts one embodiment of an Internet Remote and a companion browser for an Internet-based search system in which the user has selected a web site name and a search term has been passed to that site within an Internet Remote for an Internet-based search system according to one embodiment of the present invention.

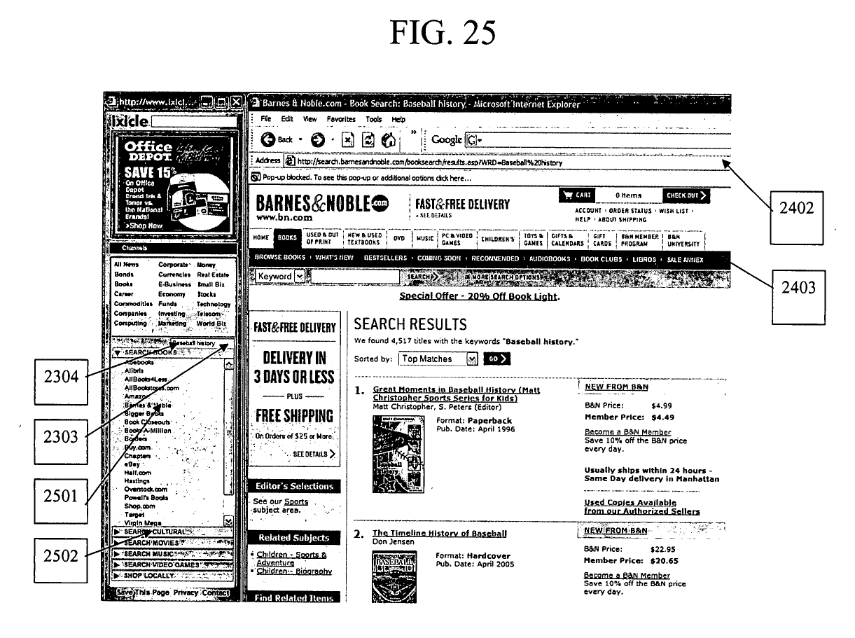

FIG. 25 depicts one embodiment of an Internet Remote and a companion browser for an Internet-based search system in which the user has selected a different web site and a search term has been passed to that site within an Internet Remote for an Internet-based search system according to one embodiment of the present invention.

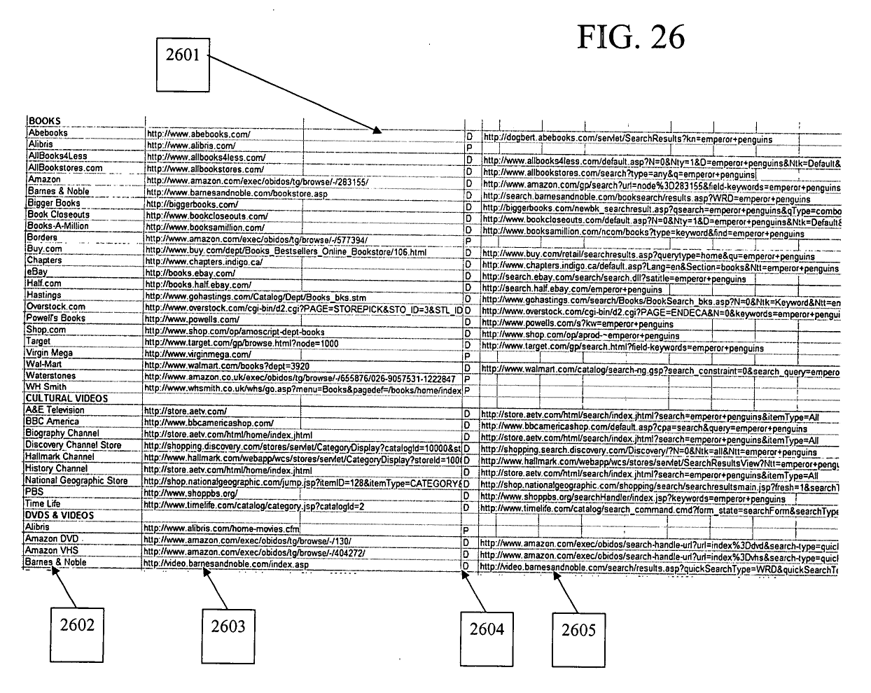

FIG. 26 depicts an excerpt of a computer database that contains pre-built search functions for a pre-defined set of web sites within an Internet-based search system according to one embodiment of the present invention.

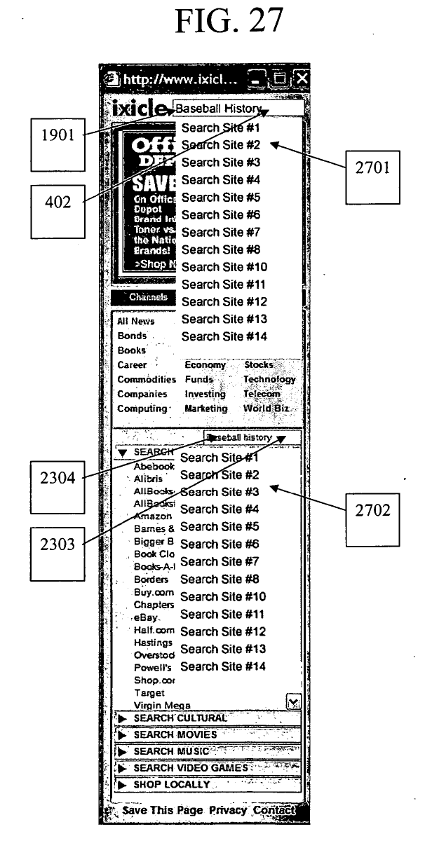

FIG. 27 depicts one embodiment of an Internet Remote in which a search term may be passed to any of a pre-selected list of web sites through the use of one or more integrated listings of such web sites within an Internet Remote for an Internet-based search system according to one embodiment of the present invention.

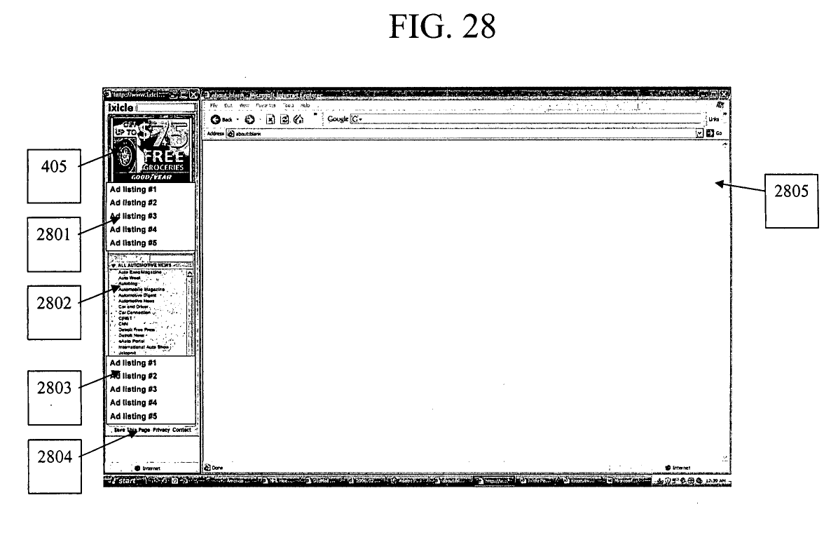

FIG. 28 is an illustrative instance of an Internet Remote and companion browser for an Internet-based search system according to one embodiment of the present invention, depicting possible advertising and promotional spaces within the system.

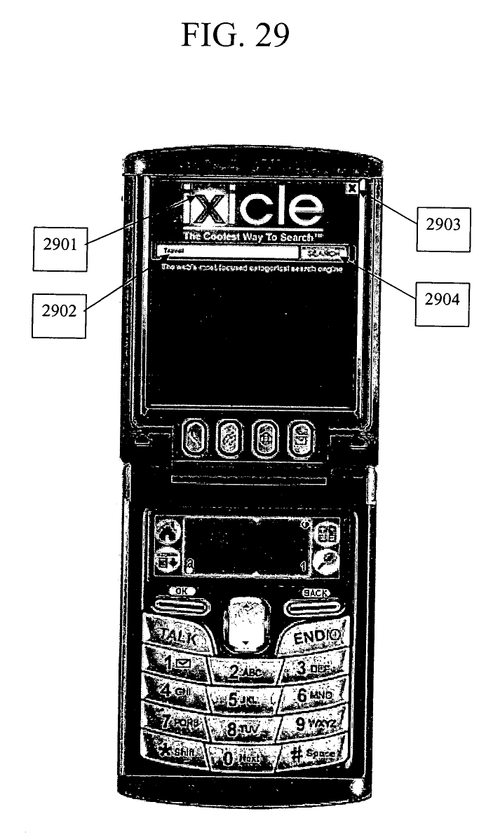

FIG. 29 is an illustrative screen of an Internet-based search system according to one embodiment of the present invention, depicting one embodiment of a deployment of the invention on a cell phone, personal digital assistant (PDA), or other handheld computing or wireless device, after one clicks onto the invention's search system icon from the device's navigation palette or other means.

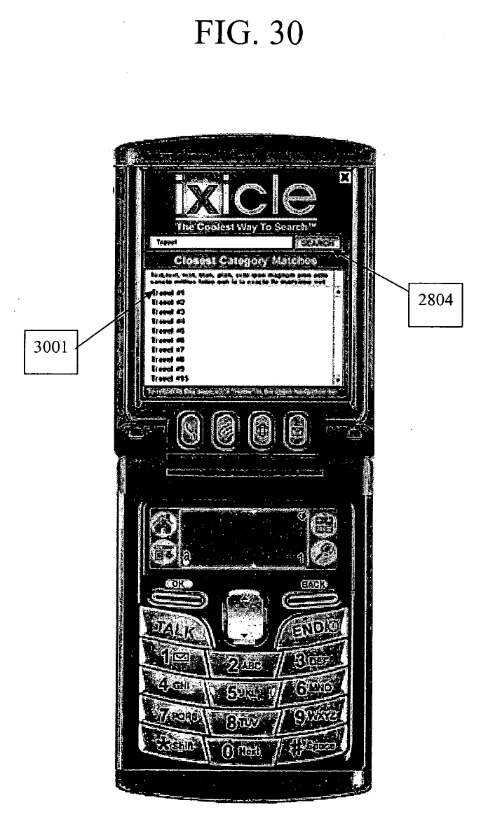

FIG. 30 is an illustrative screen of an Internet-based search system according to one embodiment of the present invention, depicting one embodiment of a deployment of the invention on a cell phone, personal digital assistant (PDA), or other handheld computing or wireless device, after a search has been conducted from the invention's search box.

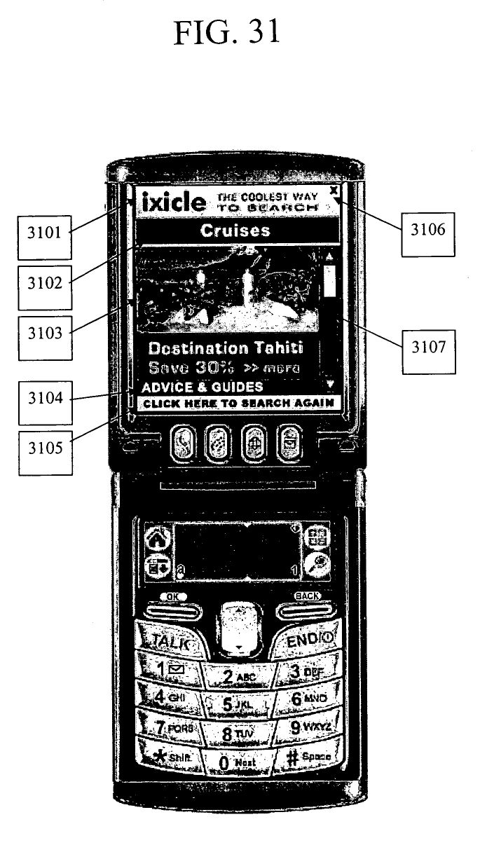

FIG. 31 is an illustrative screen of an Internet-based search system according to one embodiment of the present invention, depicting one embodiment of a deployment of the invention on a cell phone, personal digital assistant (PDA), or other handheld computing or wireless device, after a category has been selected from the invention's category search results page.

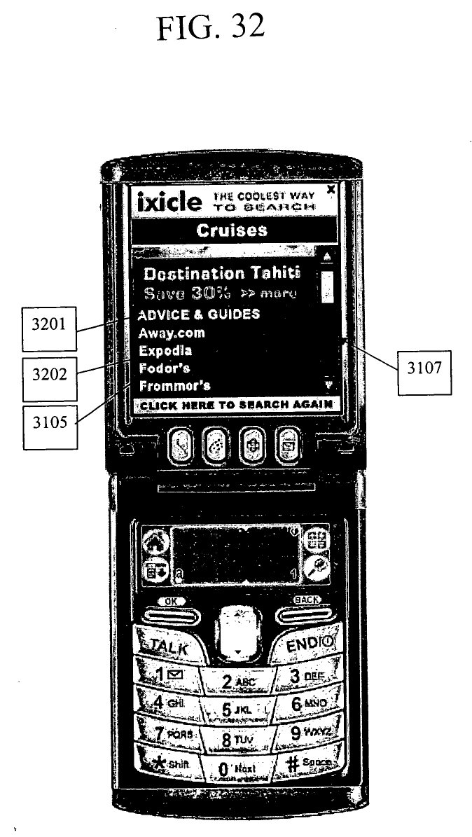

FIG. 32 is an illustrative screen of an Internet-based search system according to one embodiment of the present invention, depicting one embodiment of a deployment of the invention on a cell phone, personal digital assistant (PDA), or other handheld computing or wireless device, after the user has begun to scroll down the invention's site results in a particular search category.

### DETAILED DESCRIPTION OF THE DRAWINGS

Reference will now be made in detail to an embodiment of the present invention as illustrated in the accompanying drawings. The same reference numbers are used throughout the drawings and the following description to refer to the same or like parts.

A. The Database

It is noted that reference is periodically made within this document to various electronic databases of web site links, index terms, and other data, with such databases being “connected to” or “attached to” or otherwise associated with the invention. These databases can be formatted as a single database or multiple databases, without limiting the scope or the operation of the invention, and no distinction is meant to be implied by the use of the singular form of “database” throughout this document. Any such databases are presumed to be structured as standard informational databases and to be connected to the invention in the manner conventionally employed for connecting informational databases to web sites, as would be apparent to one of ordinary skill in the art. The database, generally speaking, containing a variety of “hand-picked” Internet sites—which are then further categorized to create the efficient search systems described herein. A variety of database architectures that would be suitable for use with the present invention would be apparent to one of ordinary skill in the art provided it is capable of being so categorized.

B. The Home Page

The “Home Page” is the first page of a web site that a user sees when navigating to that site by typing the site's unextended web address (e.g., www.ixicle.com) into the address line of a web browser. FIG. 1 is a home page of an Internet-based search system according to one embodiment of the present invention. In this illustration of a home page, the user enters a search term in the search box 101 and either presses the “Enter” button on the user's computer keyboard or else click's the “Go” indicator 103. The home page also contains a company name and/or logo 102, and a customizable background image 104. Finally, there is a navigation palette 105, which may contain links to internal pages of the application.

Through means apparent to one of ordinary skill in the art, the product name, logo, tag line 102, and background 104 can be placed on the home page interface in such a way that they can be dynamically and automatically replaced, according to assignments either manually or automatically inserted into and thereafter maintained within the attached electronic database, either by the system operator or by a company or organization that has chosen to private-label the invention. Alternatively, an individual user of the invention may replace the background image 104 by selecting from among images supplied by the system operator or from another source.

FIG. 2 shows an application home page with a customized background image 201, such as might have been chosen in any of the aforementioned ways. However the background image is chosen, a “cookie” on the user's computer can contain a small piece of computer code that is uniquely associated with the system operator's background choice, the private-labeling partner's background choice, or the user's background preference. Thus, in the case of a customized background image, when the user logs on to the system home page, the connected electronic database associates the code on the user's computer with the appropriate name and/or tag line contained within that database, and displays those items on the home page.

Alternatively, this customized background may be associated with a particular URL. Thus, when the user types this specific URL in his or her web browser or clicks a web link on another web site, again, the customized background that has been associated with that particular URL (or it could be one of many that trigger the particular customized background) is displayed. It is also noted that the mechanics whereby the background image associated with a particular URL or other trigger, could be accomplished in a viariety of ways that would be apparent to one of ordinary skill in the art.

In another embodiment of the invention, the home page backgrounds 104, 201 can dynamically and automatically be populated by advertisements or other content or functionality. In yet another embodiment of the invention, the home page can be configured in such a way that it serves as a “gateway” page into a sub-segment of the system database and/or functionality. FIG. 3 depicts a home page that has been configured in this way.

In this embodiment, the home page background 302 can be populated with content and images relevant to that sub-segment, and a custom name, logo, tag line, or title 301 can be used to replace the public name, logo, and tag line 102.

C. The Internet Remote

FIG. 4 depicts one embodiment of a remote screen. This screen appears when a user enters a search term in the search term box 101 (which could be on a home page website or a third party website) and hits the “Go” button 103 (or its equivalent), as discussed above. This remote screen includes an Internet Remote or “web remote” 401 along with a companion browser 412.

In another embodiment of the invention, the remote screen is activated through one or more drop-down lists containing names of categories contained within the application's database. In another embodiment of the invention, the remote screen may be accessed by a link, icon, or other means placed either manually or automatically within the web browser itself or within a web browser toolbar. In yet another embodiment of the invention, the remote screen may be accessed by a link, icon, or other means placed either manually or automatically on a user's computer “desktop,” in the computer's icon “tray,” in the computer's start menu or panel, or elsewhere in a visible location on a user's computer. These examples are meant to be illustrative only and not limiting of the ways in which the invention may be accessed or launched.

However the remote screen is accessed, as noted above, it generally includes two elements: (1) an Internet remote 401; and (2) a companion browser 412. In various embodiments and instances of the invention, the companion browser 412 may or may not open at the same time that the Internet remote 401 is opened. In one embodiment of the invention, the web remote 401 opens in the upper left-hand corner of the user's computer screen, and a separate web browser window (“companion window”) 412 opens adjacent to the web remote 401. In another embodiment of the invention, the Internet Remote 401 is programmed to “float above” the companion browser 412, with the user able to move the Internet Remote 401 around on his computer screen. In another embodiment of the invention, the Internet Remote 401 is hidden from view and either “pops up” or “slides out” from the web browser interface when summoned by the user, and subsequently disappears after use. In yet another embodiment of the invention, the Internet remote 401 is integrated into the web browser itself, and the content opens in a separate location within the same web browser. Again, these examples are meant to be illustrative only and not limiting of the ways in which the invention may be displayed and its elements located on a user's computer screen.

The illustrated embodiment of FIG. 4 contains a number of components, any number of which may or may not be present in a particular alternative embodiment of the invention. The Internet Remote 401 as illustrated in FIG. 4 includes:
(a) A title bar 402 that may contain the name of the system operator. Alternatively, the invention may be programmed such that the title bar contains instead the name of a private-labeling distribution partner or other third party. The name, logo, and colors used on the title bar are determined, in one embodiment of the invention, by assignments either manually or automatically inserted into and thereafter maintained within an attached electronic database, either by the system operator or by a company or organization that has chosen to private-label one or more embodiments of the present system. These assignments are registered and displayed on a user's computer through the use of a “cookie,” as described above, through a unique launching URL, through a unique launching link, or other similar means—the mechanics of which would be apparent to one of ordinary skill in the art.
(b) A search box 403 allows a user of the application to search through the attached electronic database, as well as to perform other functions as described below. In one embodiment of the invention, when the user enters a search term in the search box 101 of the home page (or a third party's website), that same term is “passed to,” or replicated in, the search box 403 incorporated within the Internet Remote when the remote screen is launched. Alternatively, if no search term has been entered in a home page search box or if the Internet Remote is launched directly without the intermediation of a search term, no search term will be present in the search box 403. In one embodiment of the invention, the user thereafter may modify, replace, or insert a new search term in the search box 403 in order to execute a search directly within the Internet Remote 401. Alternatively, as described in more detail below, the user may use the search box 403 to search within specific Internet web site, or the user may enter a web site URL in order to use the search box 403 in the same modality as a standard address bar 413 in a standard web browser. These uses of the search box 403 are meant to be illustrative only, and not limited of the types or range of searches or other functions that may be performed from a search box 403 incorporated within an Internet Remote 401.
(c) A drop-down arrow and list or similar navigational device placed, in one embodiment of the invention, in an area 404 to the right of the search box 403. The function of this navigational device is further described below.
(d) One or more advertising windows 405 that are used to display advertisements, promotions, instructional materials, or other content within an Internet Remote 401. These advertisements or other content may be of any variety of forms: graphics, text, web links, animated graphics, Flash graphics, video, or other form. In one embodiment of the invention, the advertisements or other content are associated, either manually or automatically, with information or shopping channels, information or shopping categories, information or shopping subcategories, or “keywords” in the attached electronic database. In one embodiment of the invention, the search term entered into a home page search box 101, the Internet Remote search box 403, or elsewhere, or else the channel, category, subcategory, topic areas, or web site links selected by the user (in the manner described below), determine the identity, nature, order, repetition, and/or duration of the advertisements or other content displayed in the advertising window 405. For instance, if a user were to insert the term “gas grill” in the search box 101, or else select a category like “barbecue grills” from the Internet Remote's 401 navigational system, an advertisement like that shown in the illustrated advertising window 405 might be displayed.

As noted, the advertising window 405 can contain a wide variety of content that is displayed in a wide variety of ways. In one embodiment of the invention, different advertisements cycle in either a pre-defined or random order during the entire time in which the user has the Internet Remote 401 open to a particular category or set of search results. In another embodiment of the invention, one or more instances of promotional, informative, or other video content plays within the advertising window 405 while the user has the Internet Remote 401 open to a particular category or set of search results. In another embodiment of the invention, the users may select from a drop-down list or other navigational display a specific instance or range of graphic, textual, or video content to display in the advertising window 405. In another embodiment of the invention, the content displayed within the advertising window 405 is determined wholly or in part by the user's geographic location, such as his Zip Code or Internet IP address, with the association governed by relationships established either manually or automatically within an electronic database attached to the invention. In another embodiment of the invention, the advertising window 405 may contain a web-based “form” that the user is asked to complete. In another embodiment of the invention, a user's “clicking” on the content within the advertising window 405 causes the window to become an enlarged overlay in which the size of the content (for instance, the viewing size of a video stream) is increased. In yet another embodiment of the invention, a user's “clicking” on the content within the advertising window 405 causes a web site or web page to open in the companion browser 412. The specific web site or page that opens is determined by a relationship defined, either manually or automatically, within the attached electronic database (in a manner similar to that discussed above). The above examples are intended to be illustrative only of the content that may be displayed within an advertising window included within the Internet Remote 401. Other known advertising configurations that would be suitable for use within the advertising window 405 would be apparent to one of ordinary skill in the art.
(e) A channel selector 406 that allows a user of the Internet Remote 401 to navigate among the information or shopping channels contained within the system's navigational structure and/or attached electronic database. The operation of such a channel selector 406 is described below.
(f) A navigation palette 407 that allows a user of the Internet Remote 401 to navigate among the information or shopping categories or topic areas contained within the system's navigational structure and/or attached electronic database. The operation of such a navigation palette 407 is described below.
(g) A navigation panel, or Dataset Panel 408, including a suite of interactive subcategory bars 409. In one embodiment of the invention, each section of the navigation panel 408 associated with a particular subcategory bar contains one or more web site links 410. In one embodiment of the invention, a user's clicking on one of these links 410 causes the web site or page associated with that link 410 to open in the companion browser 412. The navigation panel 408 enables a user of the invention to navigate among the information or shopping subcategories and web sites or pages contained within the invention's navigational structure and/or attached electronic database. The operation of such a navigation panel is described in more detail below.
(h) A set of links 411 to additional content within the system. The links 411 may operate either directly, through a pop-up list or other subsidiary navigational structure, or by populating the companion browser 412 with content.

In one embodiment of the invention, the Internet Remote 401 is a web-based application (that is, set of computer programming instructions, graphics, content, and data) that is contained within a standard web browser window. In one embodiment of the invention, the web browser window containing the Internet Remote 401 is automatically sized to fit the dimensions of the Internet Remote graphics, is automatically constrained so that it is not resizable, is automatically forced to open without web browser controls, web address bars, or related browser elements, and/or is constrained to open in a particular location on a user's computer screen. In certain embodiments of the invention, the system's programming structure is able to determine the operating system of a user's computer and the model and version of the web browser being used, and so configure the Internet Remote 401 upon opening in a way that will perform optimally for that operating system and web browser environment. In another embodiment of the invention, the Internet Remote 401 opens in an assigned space within the user's current web browser, and so becomes an integrated part of a single web browser. In yet another embodiment of the invention, the Internet Remote 401 is programmed as a standalone computer software application, which a user may load or download onto his computer and subsequently install on his computer. In the latter case, the Internet Remote 401 may be programmed to operate independently of the Internet or web-browsing environments. The above examples are intended to be illustrative only of the ways in which an Internet Remote 401 and/or the invention may be programmed to display and/or operate, and should not be construed as limiting of the ways in which an Internet Remote 401 and/or the invention may be programmed to display and/or operate.

The invention's companion browser 412 is a separate and independent web browser window. In some embodiments of the invention, it is constrained to open at a specific size and a specific location, but otherwise functions as a standard web browser, with all of the controls and functionality of a web browser that is launched and that operates independently of the invention. In one embodiment of the invention, the companion browser 412 serves as the target browser for web site and web page links and other content selected within the Internet Remote 401.

In certain embodiments of the invention, the Internet Remote 401 and companion browser 412 possess a number of interdependent characteristics. These include:
(a) The user may click a button, text link, icon, or other element in the Internet Remote 401 to instruct the invention to save the page currently open in the companion browser 412 into a “favorites list” within the user's instance of the invention. This favorites list may be maintained in a “cookie” file on the user's computer, on computer servers belonging to the invention's owner, or in other ways that would be apparent to one of ordinary skill in the art. The favorites list may be displayed in a variety of ways including, but not limited to, within existing instances of the navigation panel 408, or in separate instances of the navigation panel 408.
(b) The invention may automatically and without the need for user intervention remember and store the “history” of sites that the user has visited while browsing or searching the Internet with the use of the present system. This history list may be maintained in a “cookie” file on the user's computer, on computer servers belonging to the system operator, or in a variety of other manners that would be apparent to one of ordinary skill in the art. The history list may be displayed in a variety of ways including, but not limited to, within existing instances of the navigation panel 408, or in separate instances of the navigation panel. In various embodiments of the invention, this history list may or may not include web sites or pages that the user views in the companion browser 412 while the Internet remote 401 is open but that the users accesses using only the controls and address bar of the companion browser 412.
(c) In certain embodiments of the invention, web sites, web pages, and other content selected from within the Internet Remote 401 display in the current instance of the companion browser 412, replacing that browser's previously existing content. In certain embodiments of the invention, should the companion browser 412 be closed or minimized, the system will restore the companion browser 412 to its previous location upon the selection of a new web site, web link, or other content from the Internet Remote 401. In certain embodiments of the invention, should a web site, web page, or other content summoned either from the Internet Remote 401 or the companion browser 412 cause the companion browser 412 to resize, to spawn additional browser windows, or otherwise to cause the relationship between the Internet Remote 401 and the current companion browser 412 to be broken, the system will automatically close any resized or spawned windows upon the user's selection of a new web site, web page, or other content from within the Internet Remote 401 and will launch a new companion browser 412 that thereafter will become the target browser window for web site, web page, or other content selections from within the Internet Remote 401.
(d) In other embodiments of the invention, should a user manually resize or maximize the companion browser 412, the system will automatically restore the companion browser 412 to its previous size upon the user's selection of a new web site, web page, or other content from within the Internet Remote 401.

It is noted that the mechanics of the foregoing embodiments could be accomplished through a variety of programming mechanisms that would be apparent to one of ordinary skill in the relevant art. Thus, the present invention is for the overall system and its method of use, and not for the specific coding making up its component parts.

FIG. 5 depicts one embodiment of an Internet Remote 401 for an Internet-based search system in which a user may choose among a variety of pre-defined channels of information, shopping products, travel destinations, or other content. When a user clicks on the channel bar 406, a list of information, shopping, and other content channels contained within the invention is displayed. In one embodiment of the invention, this list is displayed as a drop-down list 501, although other known means of display are also considered to be within the scope of the present invention. When a user selects a channel from within the drop-down list 501 (for instance, by clicking on it), this selection causes a collection of categories to appear. In one embodiment of the invention, this collection of categories is displayed in the navigation palette 407 (partially obscured in FIG. 5). The navigation palette 407 is described in more detail in connection with FIG. 7, below.

FIG. 6 provides an illustrative example of one embodiment of a channel navigation system used for displaying content within an Internet Remote 401 according to one embodiment of the present invention. The data excerpt 601 is contained within the connected electronic database. In one embodiment of the invention, the database contains the names of various information, shopping, and other content channels 602, which it has been programmed to associate with a given information, shopping, or other content category space 603 within the database. The letters 604 are employed, in some embodiments of the invention, for programming convenience. Note that the database excerpt 601 is illustrative only, and that the exact nature and content of the database so represented may be different depending upon the precise embodiment of the invention and, indeed, may change over time as it is modified and updated regardless of the embodiment being employed.

FIG. 7 depicts one embodiment of an Internet Remote 401 for an Internet-based search system in which a user may choose among a variety of pre-defined sub-channels or categories of information within a given information channel. In one embodiment, the label visible in the channel bar 406 indicates the information, shopping, or other content channel that the user is viewing. Thus, in FIG. 7, it is as though the user selected the “Sports” channel. Then, when the “Sports” channel is selected, one or more sets of associated categories 702 are displayed. These categories 702, in one embodiment of the invention, are presented in an arrayed form on the navigation palette 407. When a user selects any of the categories 702, that category is highlighted, as illustrated in one embodiment by the shaded item 701, and the content (“Dataset”) associated with that category 701 automatically opens in the navigation panel 408.

As discussed in connection with FIG. 4, the content associated with a given category is presented in such a way, in one embodiment of the invention, that it is segmented into a number of subcategories, each of which, in one embodiment of the invention, is displayed in one of a set of subcategory bars 409. The subcategory bars are dynamic, in that, upon an appropriate user actions, they can expand and contract, open and close, or undertake some other form of dynamic reveal so that only a portion of their underlying content need be visible at any given time. In one embodiment of the invention, when a subcategory bar 409 is selected (such as by the user's clicking on it), the associated subcategory name is highlighted and the web sites or web pages 410 associated with that subcategory bar 409 in the connected electronic database are displayed in some ordered fashion in the navigation panel 408. When a user clicks on one of the web site or web page names 410 contained within the navigation panel 408, in one embodiment of the invention, that web site or page opens in the invention's companion browser 412 (not shown in FIG. 7).

FIG. 8 depicts one embodiment of an Internet Remote 401 for an Internet-based search system in which a user may use the sub-category navigation bars to view additional content according to one embodiment of the present invention. Specifically, in one embodiment of the invention, if a user selects a subcategory bar 801 other than the one that is initially selected (opened, or highlighted) when the content associated with a given category is first displayed, the previously open subcategory closes (or collapses), and the newly selected subcategory bar 801 opens (or expands), revealing the list of web sites or web pages 802 that are associated with this newly selected subcategory bar 801. In one embodiment of the invention, the previously selected subcategory bar loses its highlighted, and the newly selected subcategory bar 801 is now highlighted. In certain embodiments of the invention, web sites or pages 802 are similarly highlighted as they are selected and their contents displayed in the companion browser 412. In addition, in certain embodiments of the invention, if the number of web sites or pages 802 associated with a particular subcategory bar 801 are greater than can be displayed within the area available, a scroll bar 803 or other form of within-list navigation automatically appears, allowing the user to quickly navigate through the list of web sites and pages 802.

FIG. 9 is an illustrative example of one embodiment of a category structure used for displaying content within an Internet Remote according to one embodiment of the present invention. The category structure data excerpt 901 presented in FIG. 9 is such as may be maintained in the connected electronic database. In one embodiment of the invention, such a dataset may contain such elements as the channel name 902, the names of the various categories 903 associated in an attached electronic database with a given channel 902, and the name of the Dataset 904 that is associated in the attached electronic database with a given category 903. When the user selects a category 702 from the navigation palette 407, as displayed in FIG. 7, the user's action is passed to the attached electronic database such as that depicted in excerpt 901 in FIG. 9, whereupon the Dataset 904 that is associated in the attached electronic database with the selected category 903 is called, and the contents of that named Dataset 904 are opened in navigation panel 408 as depicted in FIG. 7. The letters and numbers 905 are employed, in some embodiments of the invention, for programming convenience. Note that the database excerpt 901 is illustrative only, and that the exact nature and content of the database so represented may be different depending upon the precise embodiment of the invention and, indeed, may change over time as it is modified and updated regardless of the embodiment being employed.

FIG. 10 depicts one embodiment of an Internet Remote 401 for an Internet-based search system in which a user may choose among an extended number of pre-defined categories of information via an embedded list. In some embodiments of the invention and for some information, shopping, or other content channels, when a channel 406 is selected, in addition to displaying its principal associated categories 702 in the Internet Remote's 401 navigation palette 407, it also may display a supplementary embedded list 1001. When the user selects the embedded list 1001, such as by clicking on it or passing his computer cursor over it (“mousing over it”), in some embodiments of the invention, the embedded list is automatically called and is displayed for the user's review, as depicted in FIG. 11.

FIG. 11 depicts one embodiment of an Internet Remote 401 for an Internet-based search system in which a user may choose among an extended number of pre-defined categories 1102 of information via an embedded list 1101, now opened. The embedded list 1101 may take any number of forms, including but not limited to a drop-down list, pop-up list or a floating panel. Depending upon the number of supplementary categories 1102 contained within the list 1101, the embedded list 1101 may be scrollable. In one embodiment of the invention, as the user scans the list 1101, the categories 1102 within the list are highlighted as the user's computer cursor passes over them. If the user selects a category 1102 within an embedded list 1101, the embedded list 1101 automatically closes and the Dataset associated in the attached electronic database with the selected category 1102 opens in the navigation panel 408 in the same manner as if a category 701 had been selected from the navigation palette 407, as illustrated in FIG. 7 (including, in some embodiments, the appearance of the subcategory bars 409, with which the various website links 410 are associated).

FIG. 12 is an illustrative example of an excerpt of a category-specific dataset as displayed in the navigation panel (Dataset Panel) of an Internet Remote for an Internet-based search system according to one embodiment of the present invention. The database excerpt 1201 is illustrative of data that may be maintained in an electronic database connected with the invention. In this illustration, the database excerpt 1201 contains both subcategory titles 1202, which display on the subcategory bars 409, as depicted in FIG. 7, above, and web site and web page titles 1203, which display as web site and web page titles 410 in the Internet Remote's 401 navigation panel 408, as depicted in FIG. 7. The content and organization of the data within this database excerpt 1201 is illustrative only, and the actual manner of organization and presentation may vary, depending upon the particular embodiment of the invention, the information, shopping, or other content channel chosen, and the information, shopping, or other content category chosen. The actual manner of organization and presentation also may vary over time.

FIG. 13 is an illustrative example of an excerpt of a category-specific dataset as displayed in the navigation panel (Dataset Panel) of an Internet Remote for an Internet-based search system according to yet another embodiment of the present invention, in which the data is further subdivided into classes. The database excerpt 1301 is similar to that depicted in FIG. 12 and is illustrative of data that may be maintained in an electronic database connected with the invention. As in that case, the database excerpt 1301 may contain both subcategory titles 1202 and web site or web page names 1203. In certain embodiments of the invention and in certain Datasets, however, the web site or web page names may consist of two parts: a prefix or class designation 1302 along with the web site name itself. These class designations are maintained in the connected electronic database, and may be used to order the web site and web page names 1203 in a particular format within the context of their respective subcategories 1202. The content and organization of the data within this database excerpt 1301 is illustrative only, and the actual manner of organization and presentation may vary, depending upon the particular embodiment of the invention, the information, shopping, or other content channel chosen, and the information, shopping, or other content category chosen. The actual manner of organization and presentation also may vary over time.

FIG. 14 is an illustrative example of an excerpt of the computer database underlying a Dataset component of an Internet-based search system according to one embodiment of the present invention. The database excerpt 1401 is similar to that depicted in FIG. 12 and is illustrative of data that may be maintained in the connected electronic database. More specifically, the database excerpt 1201 depicted in FIG. 12 is illustrative of a subset of the more complete database excerpt 1401 depicted in FIG. 14. The database excerpt 1401 is illustrative of what, in some embodiments of the invention, is referred to as a “Dataset,” and that, in these embodiments, serves as the “unit of operation” for the invention. The data that serves as the content of each individual dataset may be either pre-defined through some combination of human-edited manual development and/or machine-based generation, or else it may be dynamically generated through some combination of human-established rules and/or machine manipulation. The content and organization of the data within this database excerpt 1401 is illustrative only, and the actual manner of organization and presentation may vary, depending upon the particular embodiment of the invention, the information, shopping, or other content channel chosen, and the information, shopping, or other content category chosen. The actual manner of organization and presentation also may vary over time.

In FIG. 14, the illustrative database excerpt 1401 contains subcategory titles 1202 and web site or web page names 1203, as described previously. In addition, the database excerpt 1401 also contains the Dataset name 1403. The Dataset name 1403 corresponds in some embodiments of the invention, to the respective Dataset name 904 referenced in connection with FIG. 9, above. In addition, the database excerpt 1401 also contains a web site or web page URL 1404 that is uniquely associated with each web site or web page name 1203 within any given Dataset. This association is such that, when a user selects a particular web site or web page name 1203 within the Internet Remote's navigation panel 408, as illustrated in FIG. 7, above, the uniquely associated web site or web page URL 1404 is automatically passed to and opens in the invention's companion browser.

D. The Search Function

FIG. 15 depicts one embodiment of a home page of an Internet-based search system according to one embodiment of the present invention, in which a search term has been entered into a search box 101 on the home page. In order to operate the invention from a home page, a user may, in one embodiment of the invention, enter a search term 1501 in a search box 101 and then either press the “Enter” key on the computer keyboard or else click the “Go” indicator 103. In either case, the search term 1501 is passed, as typed, to the attached electronic database, as well as to the Internet Remote.

FIG. 16 depicts one embodiment of an excerpt of one of a collection of computer database indexes against which a search may be executed and the results displayed within an Internet Remote for an Internet-based search system according to one embodiment of the present invention. In certain embodiments of the invention, there are one or more “Index” databases attaches to the invention. An excerpt 1601 of such an Index database is illustrated in FIG. 16. This excerpt is illustrative only. The Index databases attached to the invention may be organized and constituted in a variety of ways, and the illustration is not intended to be limiting in any way.

In the database excerpt 1601, one or more columns of each Index database contains a list of index terms 1602 that have been manually or automatically identified and compiled. In one embodiment of the invention, each index term 1602 is manually or automatically associated with a Dataset 1607. In certain embodiments of the invention, this association determines which Dataset is called and displayed in an Internet Remote should a user subsequently select a specific search term 1602 from the invention's search results. At the same time, other associations within the Index database may determine which information, shopping, or other content channel 1604 is displayed, which information, shopping, or other content category 1605 is displayed, which subcategory 1606 within the displayed category 1605 is open (or expanded) upon display, and which web site or web page URL 1608 is displayed by default in the companion browser when the Dataset 1607 is opened and displayed in the Internet Remote. In some embodiments of the invention, additional letters and numbers 1603 contained in the database may be used for programming convenience.

In certain embodiments of the invention, the web site and web page URLs 1608 may be associated with a given Index term 1602 either manually or automatically. The web site and web page URLs 1608 also may be selected, either randomly or in some structured or ordered fashion, from among a set of URLs (not shown in FIG. 16) that are associated with a given Index term. In addition, one or more video window ads (not shown in FIG. 16) may be associated with a given Index term in an attached Index database and thereafter may subsequently be displayed in an Internet Remote advertising window 405, as illustrated in FIG. 4, when the Dataset 1608 associated with the Index term 1602 is opened in an Internet Remote. Also, other advertising links (not shown) may be associated with a given Index term in an attached Index database and thereafter may be displayed elsewhere in the Internet Remote (such as within a dynamically created subcategory) or in the companion browser (such as in a manually or dynamically populated web page containing multiple advertisements). In addition, all of the web sites and pages, advertisements, and web links referenced here and in an attached Index database may be manually or automatically associated in an attached Index database with a particular geographical indicator (such as a city name or Zip Code), and may be preferentially displayed in their respective locations within the invention when the Dataset 1607 associated with a given Index term 1602 is displayed within an Internet Remote. This geographical assignment may be made in any number of ways, such as through the user's having entered a preferred Zip Code into the invention, with that Zip Code having been stored in a “Cookie” on the user's computer, or through the automatic determination of the geographical location of the IP address for the computer from which the user is accessing the invention. The nature, content, and placement within an attached Index database for these associated web sites, web pages, advertisements, and web links, as described above, are illustrative only, and are not meant to be limiting of the nature, content, and placement within an attached Index database as these parameters may be implemented within the context of a particular embodiment of the invention.

The Index database excerpt 1601 is one of a number of Index databases that may be attached to the invention in any particular embodiment of the invention. Thus, in certain embodiments of the invention, when a search term 1501, as illustrated in FIG. 15, is entered, it is simultaneously tested against one or more of the attached Index databases 1601 in order to determine a match against the listing of Index terms 1602 respectively contained within those one or more attached Index databases 1601.

FIG. 17 depicts one embodiment of an Internet Remote for an Internet-based search system in which a search term has been passed from a search box on a home page or other page to the main search box of an Internet Remote for an Internet-based search system according to one embodiment of the present invention. In certain embodiments of the invention, the search term 1501 depicted in FIG. 15 is passed both to one or more Index databases like those described in connection with FIG. 16 as well as to an Internet Remote. In certain embodiments of the invention, the passed search term 1703 appears in the main search box 402 within an Internet Remote. In certain embodiments of the invention, the passage of this search term 1703 causes a search results panel 1701 to display within or on top of the associated Internet Remote. The search results panel 1701 may contain one or more separate and independently operating search results palettes 1702 that collectively comprise the overall search results panel 1701. In certain embodiments of the invention, each search results palette 1702 is linked with a particular attached Index database 1601 as depicted in FIG. 16. This form of the search results panel 1701 along with the placement of one or more search results palettes 1702 is illustrative only. The actual display and contents of a search results panel 1701, along with its constitution by individual search results palettes 1702, may vary according to the particular embodiment of the invention.

In one embodiment of the invention, the individual search results palettes 1702 that constitute the search results panel 1701 contain a header 1704 that may be inserted manually, may be programmed to be inserted automatically, may be dynamically drawn from the attached electronic database, or may be designed as a fixed part of the system interface. In certain embodiments of the invention, each independent search results palette 1702 also contains a listing of Index terms 1705 that is associated, in some pre-defined way, with the search term 1703 that has been passed to both the attached Index databases and the Internet Remote. In one embodiment of the invention, this association may be alphabetical, such that the Index terms 1602, as depicted in FIG. 16, that begin with the letters of the passed search term 1703 are displayed in the given search results palette 1703. This method of association is illustrative only. Different methods of association may be used in different embodiments of the invention, and indeed different search result palettes 1702 and different Index databases 1601 that are attached to the invention may use different association methods even within the context of the same embodiment of the invention. The illustrated association method is therefore not intended to be limiting of the actual and various association methods that may be employed in certain embodiments of the invention.

If the number of such search results 1705 is greater than can be displayed within the visual dimensions of the search results palette 1702, that list 1705 may be programmed to scroll upon user command, either by the clicking of a text command 1706, by the clicking of embedded arrows or scroll bar (not shown), or by some other means. In certain embodiments of the invention, this scrolling takes place independently within the context of a given search results palette 1702; that is, executing a scroll in one search results palette 1702 does not cause scrolling to take place in the other search results palettes that constitute a given instance of the search results panel 1701.

In certain embodiments of the invention, if the user selects a given search result or Index term 1705 as displayed within the context of a search results palette 1702 within an Internet Remote, that selection is passed to the respective attached Index database 1601. Thereafter, the search results panel 1701 is automatically closed, and the Dataset 1607 associated with the selected Index term 1602 opens in and populates the Internet Remote, opening (or expanding) to the subcategory 1606 so indicated in the attached Index database. Simultaneously, in certain embodiments of the invention, the channel 1604 and category 1605 associated with given Index term 1602 display in their respective navigation areas 406 and 407 of the Internet Remote, while any associated default URLs 1608 open in the companion browser and any other associated advertisements or web links (not shown) display in their respective and assigned positions within the Internet Remote.

FIG. 18 depicts one embodiment of an Internet Remote in which a search term has been entered or modified within the main search box of an Internet Remote for an Internet-based search system according to one embodiment of the present invention. The search term 1801 may have been passed from a home page search box and is now being manually modified by the user of the invention. In such a case, the search results panel 1701 was already open and remains open while the user is modifying the search term 1801. Alternatively, the user may have entered the search term 1801 directly into the main search box 402 of an Internet Remote; in such case, the search results panel 1701, which will not have been open, is automatically displayed in response to the user's input of a search term 1801. This method of display is illustrative only, and is not meant to be limiting of the way in which search results are displayed in particular embodiments of the invention in response to the user's input of a search term 1801.

In certain embodiments of the invention, as the user enters or modifies a search term 1801 in the main search box 402 of an Internet Remote, the search results or Index terms 1705 that are displayed in the various search results palettes 1702 that constitute the search results panel 1701 dynamically and automatically adjust and repopulate according to the modifications to the entered or modified search term 1801. This dynamic display of search results, so described, is mediated by real-time comparison of the entered or modified search term 1801 with the list of Index terms 1602 contained within the various attached Index databases 1601, as illustrated in FIG. 16. Each set of search results 1705 within the respective search results palettes 1702 dynamically and independently adjusts according to the particular Index database 1601 with which it has been associated. In the illustration, the contraction of the search term 1801 may cause the number of Index entries 1705 displayed within a particular search results palette 1702 to expand, depending upon the contents of the associated Index database. In such cases in which the number of search results or Index terms was sufficiently small so that all could be displayed within the context of the given search results palette, the dynamic increase in the number of search results or Index terms may cause the appearance of a scrolling function 1706, if necessary, where none was present before. In one embodiment of the invention, this passage of changes in the search term 1801 to the respective associated Index datasbases is undertaken through a Javascript “callback” so that the display of the search results lists 1705 can change without requiring the entire Internet Remote or search results panel 1701 to re-post to the user's computer screen.

FIG. 19 depicts one embodiment of an Internet Remote for an Internet-based search system in which a search term has been refined more precisely within the main search box of an Internet Remote for an Internet-based search system according to one embodiment of the present invention. Whereas, as illustrated in FIG. 18, the contraction of a search term 1801 entered into the main search box 402 of an Internet Remote may cause the expansion of the number or search results or Index terms 1705 listed in a given search results palette 1702, the expansion or increased precision of a search term 1901 entered into the main search box 402 of an Internet Remote may cause the reduction in the number of search results or Index terms 1705 displayed within the various search results palettes 1702 that constitute the search results panel 1701 of the Internet Remote. As before, changes in the search term 1901 are passed to the various Index databases 1601 associated with the respective search results palettes 1702, and the consequent search results 1705 are dynamically and automatically displayed within the respective search results palette 1702. In some cases, even with the enhanced precision in the entered or modified search term 1901, search results 1705 still will be present in a given search results palette 1702. In other cases, depending on the content of the associated Index database 1601 and the particular rules for association that have been manually or automatically assigned and executed, there may be no search results or Index terms that match the entered search term 1901. In this case, in certain embodiments of the invention, a “no results” message 1902 may be displayed, and the user may be given the opportunity to search for his entered search term 1901 among one or more pre-defined or dynamically generated Search Datasets 1903. The method in which this function operates will be explained subsequently. The display of results or of “no results” messages operates independently for each of the search results palettes 1702 that constitute the search results panel 1701, and the particular manner or content of display for a given search results palette 1702 may vary among the different embodiments of the invention, or even among different search results palettes 1702 or different circumstances within the same embodiment of the invention.

FIG. 20 depicts one embodiment of an Internet Remote and a companion browser for an Internet-based search system in which the user has selected a named site from the search results within an Internet Remote for an Internet-based search system according to one embodiment of the present invention. In some embodiments of the invention, the search results panel 1701 contains one or more search results palettes 1702 that include, either wholly or partly, specific named web sites or web pages (or synonyms thereof). When a user clicks on a named site entry 2001 within this search results palette 1702, that request is passed to the respective associated Index database 1601, and the web site or web page URL 1608 that is associated with the respective Index term 1602 is passed to the companion browser address bar 2002, with the web site or web page associated with that URL 1608 opening in the companion browser 2003.

FIG. 21 depicts one embodiment of an Internet Remote and a companion browser for an Internet-based search system in which the user has entered a web site URL directly into the main search box of an Internet Remote for an Internet-based search system according to one embodiment of the present invention. In certain embodiments of the invention, if the user enters a web site or web page URL 2101 directly into the main search box 402 of the Internet Remote (or, alternatively, into a search box of the system operator's home page) and then presses the “Enter” button on his computer, that URL 2101 is passed directly to the address bar 2002 of the companion browser, and the web site or web page associated with the URL 2101 opens in the companion browser. A parsing engine attached to the invention uses the presence of “http://” and/or “www.” and/or other means to determine if the entered search term is, in fact, a web site or web page URL. If it so determines, there is no interaction with any associated Index databases, and no results populate the search results palettes 1702,

FIG. 22 depicts one embodiment of an Internet Remote and a companion browser for an Internet-based search system in which a category has been selected from the search results in an Internet Remote for an Internet-based search system according to one embodiment of the present invention. If the user selects a category search result (e.g., the search result “Baseball History” in the respective search results palette 1705 as illustrated in FIG. 19), the Dataset 1607 associated with that Index term 1602 in the respective associated Index database 1601 opens in the Internet Remote Dataset panel area 408, and opens (expands) the subcategory 2201 that is the designated subcategory 1606 that is associated with the Index term 1602 in the respective associated Index database 1601. Simultaneously, the default web site or web page 1608 associated with the Index term 1602 in the respective associated Index database 1601 opens in the companion browser, and any other advertisements or web links associated with the Index term 1602 in the associated Index database 1601 open, appear, or are posted in their respective positions in the Internet Remote.

Thereafter, if a user selects (such as by clicking on) a web site or web page 2202 listed in the open (or expanded) subcategory 2201 (or any other subcategory) within the Dataset panel display 408, the web site or web page URL 1404 associated in an attached electronic database 1401 with the selected web site or web page name 2202 opens in the address bar 2002 of the companion browser, and the web site or web page associated with the given web site or web page URL 1404 opens in the companion browser. In some embodiments of the invention, the web site or web page name 2202 that is selected may be highlighted. Should the user thereafter select (such as by clicking) another web site or web page name within the Dataset display 408, the same process as just described repeats, using the information associated with the new selection.

FIG. 23 depicts one embodiment of an Internet Remote for an Internet-based search system in which a search term has been passed to a pre-selected grouping of web sites in an Internet Remote for an Internet-based search system according to one embodiment of the present invention. As noted earlier in connection with FIG. 19, a search term 1901 entered into the main search box 402 of an Internet Remote (or into a home page or other search box of the invention) may yield no matches when that term 1901 is passed to the respective associated Index databases 1601. In such case, as illustrated in FIG. 19, a “no results” message 1902 is displayed, and the user is given the opportunity to search within a number of pre-selected groups of sites, each arranged, in one embodiment of the invention, into a range of subject areas 1903.

In one embodiment of the invention, if a user selects a subject area 1903, the Search Dataset associated with that subject area opens in the Dataset Panel 408 of an Internet Remote. The Search Dataset opens to either a default or a designated Subcategory 2301, which is populated by a set of web sites or web pages 2302. If the list of sites is too long to be displayed in the area available, a scrolling function 2305 may be automatically added. In one embodiment of the invention, the search term 1901 that had been passed from the main search box 402 of the Internet Remote now appears as a search term 2304 in a secondary search box 2303.

In one embodiment of the invention, the web sites or web pages 2302 listed in the subcategory 2301 of the Search Dataset display 408 may be presented in alphabetical order. In other embodiments of the invention, the web sites or web pages 2302 may be presented in order of “search density.” That is, the sites with the greatest number of results for the given search term 2304 will be presented earlier in the list, and those with a lesser number of search results will be presented later. In one embodiment of the invention, this “search density” is calculated by automatically passing the search term 2304 to a pre-selected grouping of web sites or web pages, as contained in the attached electronic database, using the respective web sites' native search engines to calculate the number of search results, automatically extracting the number of search results per site for the given search term 2304, automatically ranking the pre-selected grouping of web sites or web pages in descending order according to the number of search results found, and displaying the web sites or web pages 2302 in this calculated order within the respective subcategory 2301 of the Dataset panel 408. This specific method of calculation, ordering, and display is illustrative only, and is not meant to limit the range of calculation, ordering, and display methods that may be used by different embodiments of the invention or even by the same embodiment of the invention in different circumstances or for different Search Datasets.

FIG. 24 depicts one embodiment of an Internet Remote and a companion browser for an Internet-based search system in which the user has selected a web site name and a search term has been passed to that site within an Internet Remote for an Internet-based search system according to one embodiment of the present invention. If the user selects a web site or web page 2401 listed in the Search Dataset display (such as by clicking on the site), in one embodiment of the invention, the search term 2304 present in a secondary search box 2303 is automatically passed to one or more attached electronic databases. This database(s) contains the instructions for executing a search within the selected web site 2401 employing that site's own search function, which may be by insertion of the search term into a version of the web site's URL address, posting of the search term to the web site's search function, or other means. The attached electronic database(s) automatically yields a web site address (URL), which is displayed in the address bar of the companion browser 2402 in the manner so generated, and the target web site opens in the companion browser 2403 with the search results displayed in the same manner as if the search term 2304 had been entered directly into the web site's search box.

FIG. 25 depicts one embodiment of an Internet Remote and a companion browser for an Internet-based search system in which the user has selected a different web site and a search term has been passed to that site within an Internet Remote for an Internet-based search system according to one embodiment of the present invention. In the illustration, the search term 2304 in the Internet Remote's secondary search box 2303 has remained unchanged, but the user has selected a different web site 2501 within the listing of web sites and web pages in the Search Dataset display. The same process takes place as described in connection with FIG. 24, using one or more connected electronic databases, except for a different web site and native web site search function. The resulting, automatically generated web site address (URL) is displayed in the address bar 2402 of the companion browser, and the new, target web site opens in the companion browser 2403 with the search results displayed in the same manner as if the search term 2304 had been entered directly into this new web site's search box.

In some embodiments of the invention, the user may modify the search term 2304 in a secondary search box 2303 of the Internet Remote. If the user then selects a web site or web page 2501 within the web site and web page listing (such as by clicking on it), this new search term 2304 is instead passed to the attached electronic database(s), and the same process as described in the previous paragraph takes place. The new, automatically generated web site address (URL) is displayed in the address bar 2402 of the companion browser, and the target web site opens in the companion browser 2403 with the search results displayed in the same manner as if the new search term 2304 has been entered directly into this new web site's search box.

In certain embodiments of the invention, if the search term 2304 in a secondary search box 2303 is left blank and a web site or web page 2501 is subsequently selected (such as by clicking it), the blank nature of the search is passed to the attached electronic database(s), and a pre-determined “default” web site address (URL) stored in the database(s) is passed back to the companion browser. This default web site address is passed to the companion browser's address bar 2402, and the web site or web page associated with that web address opens in the companion browser 2403.

FIG. 26 depicts an excerpt of a computer database that contains pre-built search functions for a pre-defined set of web sites within an Internet-based search system according to one embodiment of the present invention. The excerpt of the Search database 2601 so depicted may take a variety of forms, and the particulars described here are illustrative only and are not meant to be limiting of the types, organization, structure, or contents of a Search database that might be connected to or otherwise employed as part of the invention. In one embodiment of the invention, the Search database contains web site and web site names 2602 that correspond, in one of a variety of possible fashions (e.g., alphabetical order, ranking according to “search density” as described above, and others), to the presentation of web site and web page names 2501 in the Dataset Panel display 408, as illustrated in FIG. 23 through FIG. 25.

The web site and web page addresses 2605 contained in the Search database 2601 are illustrative of the kinds of formulas that may be used to generate the web site address that is displayed in the companion browser address bar 2402, as illustrated in FIG. 23 through FIG. 25. Each formula 2605 is associated with a specific web site name 2602, although a given web site 2602 may have multiple formulas 2605 associated with it, and these formulas 2605 may take on a variety of forms, such as integrated of the search term 2304 into the standard search URL of the target web site 2602, posting of the search term 2304 to the target web site 2602, and other forms. These formulas 2605 are illustrative only and are not meant to be limiting of the actual formals that may be used in certain embodiments of the invention. The Search database 2601 also contains one or more default web site or web page addresses 2603 that are associated in the database with each web site or web page name 2602, and that are used to display in the companion browser address bar 2402 when the search term 2304 in a secondary search box 2303 of the remote is left blank.

In certain embodiments of the invention, other data 2604 may be present in the Search database that is used for programming convention, for determining which search formulas to use, and other functions. In certain embodiments of the invention, a Search database also may include default advertisements, web pages, or other web links (not shown) that open or are displayed in the Internet Remote or companion browser in their respectively assigned areas when a certain search term is entered into a home page search box, the main Internet Remote search box 402, or a secondary search box 2303 in the Internet Remote.

FIG. 27 depicts one embodiment of an Internet Remote in which a search term may be passed to any of a pre-selected list of web sites through the use of one or more integrated listings of such web sites within an Internet Remote for an Internet-based search system according to one embodiment of the present invention. If a user inserts a search term 1901 into the main search box 402 of the Internet Remote, the user may have the option, in certain embodiments of the invention, to click on a drop-down arrow or other indicator that causes a listing 2701 to appear. This listing may be in a number of forms, including a single list, a multi-panel or multi-part list with collapsible subcategories, or another form. If the user selects a web site or web page name from the list 2701, the search term 1901 is passed directly to the native search function of the site 2701 so selected, in a manner similar to that described in connection with FIG. 23 through FIG. 26, and the resulting search results open in the companion browser, in a manner similar to that described in connection with FIG. 23 through FIG. 26. If the user then selects another site from the list 2701, the same process is repeated for the same search term 1901 and the new site 2701 so selected. Subsequently, the user may modify the search term 1901 and continue the search process in a like fashion.

The site list 2701 associated with the main search box 402 and its various parameters and functions are maintained in one or more Search databases connected to the invention. The secondary search box 2302 within each information, shopping, or other content category, in certain embodiments of the invention, also is associated with a list of searchable web sites or web pages 2702 that may have the same or similar characteristics as those possessed by the list 2701 associated with the main search box 402, and may be called in the same way. In one embodiment of the invention, the list 2701 associated with the main search box 402 contains generally relevant web site and web page listings, whereas the various lists 2702 associated with the secondary search box 2303 contain web site and web page listings that are particular to the individual category within which the respective listing 2702 appears.

The contents, associations, and functions of the various lists 2702 that are associated with the secondary search box 2303 are maintained in one or more Search databases connected to the system. The search functionality of these listings 2702 are similar to that of the listing 2701 associated with the Internet Remote's main search box 402. In particular, the search term 2304 entered into the secondary search box 2303 is passed to the Search database entry for the web site or web page that the user selects from the listing 2702, the search function or association contained in the attached Search database is performed, and an automatically generated URL is passed to the companion browser, where that web site or web page URL is displayed. If the user selects another web site or web page name within the list 2702, the sarne process is performed for that web site or web page. The user also may modify the search term 2304 and perform the process in similar fashion.

The manner of display, user interaction, and functionality described above, for both the main and secondary search boxes, is illustrative only, and is not meant to be limiting of the display, user interaction, or functionality actually employed in any given embodiment of the invention.

FIG. 28 is an illustrative instance of an Internet Remote and companion browser for an Internet-based search system according to one embodiment of the present invention, depicting possible advertising and promotional spaces within the system. These spaces include, but are not necessarily limited to, the previously discussed advertising window 405, a dynamic advertising pane 2802 associated with the advertising window 405, a dynamically generated subcategory and its contents 2402 that opens or expands within the Dataset Panel display, a dynamic advertising window 2803 that pops up or otherwise appears at the bottom of the Internet Remote, and the contents of a dynamically generated companion browser web page 2805.

The contents of the advertising window 405 have been previously discussed. The two dynamic advertising panes 2801 and 2803 can contain text, graphic, animated, Flash, or video advertising that can be associated in real time, through the mediation of an attached electronic database, with the keyword or category being searched, the user's geography (as previously discussed), some other parameter, or some combination of these. The dynamically generated subcategory 2802 can be similarly populated, and can include web site or web page links like the other subcategories within the Dataset Panel display. The dynamically generated companion browser web page 2805 can be similarly generated, and can contain entire web sites or pages, whole-page advertisements, fractional-page advertisements that are either pre-constructed or dynamically generated, text-based advertising listings that are either pre-constructed or dynamically generated, video displays and presentations, or some combination of the above.

In certain embodiments of the invention, the user may employ text links or icons 2804 located elsewhere on the Internet Remote in order to save pages to an integrated “favorites” list, as discussed in connection with FIG. 4, above, in order to view or edit the user's web-browsing history through the Internet Remote, as discussed in connection with FIG. 4, above, to call certain corporate web pages (such as privacy and use policies) for display in the companion browser, to access features, promotions, and advertisements, and for other functions.

E. Handheld & Wireless Deployments

In addition to being deployable across Internet connections and in web browsers on ordinary desktop, notebook (laptop), tablet, and related computing devices, the invention is designed, in some embodiments, to be deployed over Internet connections on cellular telephones, personal digital assistants (PDAs), and other handheld computing or wireless devices featuring appropriate display screens. The display interfaces for these devices typically contain lists, “hot keys,” or digital icons that permit their users to access applications or features resident on the device. It is assumed (but not required) for purposes of this discussion that the present invention would be accessed and launched on such devices in like manner.

FIG. 29 is an illustrative screen of an Internet-based search system according to one embodiment of the present invention, depicting one embodiment of a deployment of the invention on a cell phone, personal digital assistant (PDA), or other handheld computing or wireless device, after one clicks onto the invention's search system from the device's navigation palette or other means. A logo 2901 is presented in this embodiment in a modified format from the home page depicted in FIG. 1, but the functionality is similar. The user inserts a search term in the search box 2902 and clicks the execution (“Search” or “Go”) button 2904 in order to conduct a search. Should the user wish to leave the system's interface and return to the main navigation palette at this point, he merely clicks the “Close” button 2903. Note that these screen elements may be differently displayed and certain graphical interface elements may be included or excluded in various handheld computing or other wireless device embodiments of this invention. The arrangement, organization, and inclusion of elements so depicted is illustrative only, and is not meant to be limiting of the arrangement, organization, or inclusion of elements in a particular embodiment of the invention.

FIG. 30 is an illustrative screen of an Internet-based search system according to one embodiment of the present invention, depicting one embodiment of a deployment of the invention on a cell phone, personal digital assistant (PDA), or other handheld computing or wireless device, after a search has been conducted from the search box (as discussed previously). The categorical search results are displayed in a scrollable and expandable list 3001 similar in appearance and operation to the scrollable and expandable lists 408 in certain embodiments of the Internet Remote, as depicted in FIG. 4 above. The search operation takes place similarly to the search functionality described above, and these activities are driven off the same connected electronic database(s) as referenced there. Specifically, when a user has clicked the execution (“Search” or “Go”) button 2904, the indexed topical categories associated in the connected electronic database(s) with that search term appear, in this embodiment of the invention, in a scrollable and expandable list 3001. It is important to note that the placement of the search boxes, the display format of the categorical search results, and the specific contents of the search results may vary according to need, deployment modality, and then-current Internet web site inventories. In one embodiment, following the search, the drop-down list 3001 opens to and is positioned in a location (the “landing point”) associated with the search term input by the user, according to predefined search rules that can be embedded within the system by a variety of means known to one of ordinary skill in the art. In certain embodiments of the invention, this landing point may be a particular subcategory within a Dataset, as described previously. The user thereafter may use the scrolling functionality on the scrollable list 3001 to move up and down within that search results list, or else use collapsible and expandable subcategory bars to view different elements of the results. Note that the invention can be constructed in such a way that the search rules for associating the landing point in the list with the search term input by the user may be implemented in a variety of ways, including but not limited to a strict alphabetical search according to one or more words within the search term and/or one or more of the initial letters within the initial word of the search term. These search rules may change over time according to need, deployment modality, or other factors. Note further that the screen elements depicted in FIG. 30 may be differently displayed and certain elements may be included or excluded in various wireless-device embodiments of this invention.

FIG. 31 is an illustrative screen of an Internet-based search system according to one embodiment of the present invention, depicting one embodiment of a deployment of the invention on a cell phone, personal digital assistant (PDA), or other handheld computing or wireless device, after a category has been selected from the system's category search results page. In this embodiment, the invention functions similarly to the web remote depicted and described in FIG. 8. In one embodiment, the logo and tag line 3101 are placed at the top of the screen, in fixed (non-scrolling) position, and may be clicked to return the user to the main search screen depicted in FIG. 29. The channel or category title bar 3102 is displayed below that, and may be followed by an advertisement or other content 3103. The channel or category bar 3102 may be used in a form similar to that in the Internet Remote version of the application, as described above. The advertisement or other content 3103 may be static graphics, animation, video, or some other form. Text-based advertisements and content also may be used. The number, format, and placement of advertisements and other content may vary according to need, category, or device. Channel and category titles, advertisements, and other content are drawn from the electronic database(s) connected to the invention, and the latter two sets of items may or may not be keyed to the channel, category, Zip Code, or GPS-determined location of the user in the cases in which they appear. A scrolling list of web sites 3103, described further in FIG. 32, appears below the initial advertisement or content, if it is present. At the bottom of the screen, in one embodiment of the invention, in fixed and non-scrolling position, is a clickable button 3105 that takes users back to the main search screen depicted in FIG. 29. A scroll bar or other scrolling function 3107 allows users to navigate up and down the list. A “Close” button 3106 allows users to exit the system and return to the device's main navigation palette. Note that the screen elements depicted in FIG. 31 are illustrative only and may be differently displayed and certain elements may be included or excluded in various handheld computing and other wireless device embodiments of this invention.

FIG. 32 is an illustrative screen of an Internet-based search system according to one embodiment of the present invention, depicting one embodiment of a deployment of the invention on a cell phone, personal digital assistant (PDA), or other handheld computing or wireless device, after the user has begun to scroll down the system's site results in a particular search category. Using the scroll bar or other scrolling function 3107, the user causes the screen to reveal the scrollable list of sites 3105, which in some embodiments of the invention include multiple expandable and collapsible subcategory lists 3201 of the type described above in connection with the Internet Remote. The web sites and web pages associated with the given channel or category are maintained within the connected electronic database(s). When a user clicks on the name of a web site 3202, the web site or web page name in the list 3105, the associated web site or web page opens in the device's native or default web browser. In this sense, the invention can be independent of the form of web page display within the host device, and can be consistent with any form of web page display that the device might provide. Once the user has called up a particular web site in this manner, the host device's native controls and programming determine how the user is able to return to the site list depicted in FIG. 32 or to the main system search screen depicted in FIG. 29.

Unlike other web-based applications and search engines that typically must be dramatically re-configured for deployment on cellular phones, personal digital assistants (PDAs), and other handheld computing and wireless devices, the present invention, in its various embodiments, is architected in such a way that it can be immediately deployed on such devices with a minimum of re-configuration, due in large part to the small graphical “footprint” of the Internet Remote as well as to the Internet Remote's display only of category and web site names within its display and search results. These features make it easy and quick for users to locate the information they need, in both standard and handheld computing environments—a highly desirable advantage given the limited screen size and typically lower bandwidth Internet connectivity of most common handheld computing and wireless devices. The invention can thus be an ideal vehicle for simultaneous deployment on both standard and handheld web-browsing platforms. Indeed, because of the advance of wireless technology, it may even be possible in some embodiments to display the invention's Internet Remote on certain cell phones, personal digital assistants (PDAs), and other wireless and handheld devices without graphical or programming modification.

Methods of Operation

In order to clarify the descriptions accompanying the drawings presented above, four use cases are presented below. This use cases are described in four scenarios: (1) a search from a web site or software application search box; (2) a search from an Internet Remote; (3) search from within a constrained, pre-built roster of web sites; and (4) a search from a family of drop-down lists. The terms and elements referenced in these paragraphs correspond to those in the drawings and associated textual descriptions given above. As with the description of the drawings, it is noted that these methods of operation are given as merely illustrations and are not intended to define the scope of the invention as claimed.
Use Case 1. Search from a web site or software application search box. In most traditional search engines, when a search term is entered into a search box and a search is executed, the search engine in question compares the term to one or more typically machine-compiled electronic databases of web sites and retrieves a list of web sites containing or referencing the search term, ordered by presumed relevance. For most searches and most search engines, the web sites contained within such a listing of search results number in the millions. This process is illustrated below:

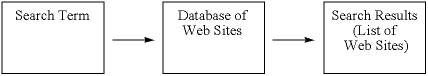

In the case of the present invention, in one embodiment, when a search term is entered into a search box (either on the system operator's web site home page, a web page maintained by a third-party entity, or from within a search box in an Internet-based or software-based computing application) and a search is executed in the default mode (that is, against the invention's categories), that search is performed against a human-edited electronic database of topical categories and synonyms (“Invention Index”) containing subjects covered by the web sites indexed within the invention's web site database (“Invention Web Site Database,” or IWSD). In one embodiment of the invention, the execution of the search (e.g., by pressing the “Enter” key on the keyboard or a search button on the web site) causes the invention's Internet Remote to open on the computer screen in a separate, independent web browser. At the same time, the web browser window from which the remote was launched (the “Companion Browser”) automatically resizes and repositions itself adjacent to the browser window containing the Internet Remote so that both the remote and the Companion Browser window are simultaneously visible. The Companion Browser window then becomes the “target window” for web sites and pages selected from within the Internet Remote.

After the search has been executed and the browser windows have opened and adjusted as just described, the user is then presented with a list of usually a few to a few dozen topical categories or synonyms most closely matching the search term (“Categorical Search Results”). In one embodiment, the results are presented in a dynamic, multi-part Search Results Panel that overlays the Internet Remote, although this method of presentation is meant to be illustrative and not limited, and other methods of presentation are equally well supported by the invention. The matching of search terms to Categorical Search Results, in one embodiment, is performed alphanumerically, but could be performed in many other ways as well, including substantively or based upon some measure of popularity as determined by the number of times that the aggregate of users employing the system selects a particular category. The alphanumeric form of matching is therefore intended to be merely illustrative and not to be considered to be limiting of the invention's scope.

After the user is presented with the Categorical Search Results, as just described, the user selects the topical category of greatest interest, and is taken to that category's dataset, which is presented in one embodiment of the application as an integrated panel (“Dataset Panel”) within an Internet Remote. This process is depicted below.

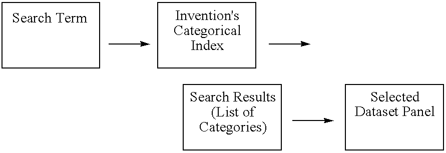

As indicated, the invention has associated with it one or more electronic database of web sites (the IWSD) that encompasses a full range of topics, including news, reference, shopping, travel, and numerous other topic areas. The IWSD is a human-edited and continuously updated electronic database of web links intended to include the majority of credible web sites covering or referencing each of thousands of the most popular topics on the Internet. As such, the IWSD consists of tens of thousands of web site home pages or interior pages (a number that also is continuously growing), organized into thousands of categorical subject areas called “Datasets.”

Each Dataset within the IWSD is an ordered list of a few to a few score web sites (home pages or interior pages), organized into logical subcategories and, within each subcategory, alphabetically. In contrast to most traditional search engines, which display long descriptions of the web sites included within its results, the Datasets include and display only the name (sometimes a shortened version of the name) of the web site being referenced. Each index term within the Invention Index is uniquely associated with a single Dataset within the IWSD. Each Dataset is embodied in the form of a multiple-subcategory, scrollable navigation list in an integrated panel within an Internet Remote called a “Dataset Panel.” In other words, the Dataset Panel is the host page for a given Dataset. When the user thereafter clicks on the name of a web site listed within the Dataset Panel's listing of web sites, the referenced web site or page is opened in the invention's Companion Browser.
Use Case 2. Search from an Internet Remote. As noted, search results in the preferred embodiment of the invention are displayed within a small, independent web browser window called an “Internet Remote.” The Internet Remote itself also contains a search box that functions, in similar respect to the web site search box described in Use Case 1. A key difference is that, when a user enters a term in the Internet Remote search box, the remote is already open, and so the search results are displayed in a Search Results Panel that overlays the existing Internet Remote interface. The Search Results Panel is dynamic in that changes in the search term (e.g., contracting or adding to a search term) generate corresponding changes, in roughly real-time, in the categorical search results displayed in the Search Results Panel.

In one embodiment, the Internet Remote provides access to all of the system's datasets, either (as described above) through categorical searching or (as described below) via direct navigation. When the Internet Remote is used in the categorical search mode, each of the system's Datasets is displayed in a similar fashion as a Dataset Panel integrated within the Internet Remote. When the user clicks on a web site name within the Internet Remote's navigation list, that referenced web site opens in a new, companion web browser window in such a way that the Internet Remote and the new browser window simultaneously remain viewable on the user's computer screen. When the user clicks on a subsequent web site name within the Internet Remote's navigation list, the referenced site replaces the then-existing content within the companion browser window. Note that the above description presents merely one embodiment of an Internet Remote, in particular, of a categorically based Internet Remote. Similar instances of an Internet Remote, with different orientation and content, may be launched from different locations within the invention's web site home page or other third-party web sites. In addition, rather than being placed in a separate browser window, the Internet Remote or some subset of its display and content may be presented as an integrated component of a web browser or other Internet-based or software-based application The above description is therefore intended to be illustrative of the operation of an Internet Remote and is not to be considered to be limiting of the invention's scope.
Use Case 3. Search from within a constrained, pre-built roster of web sites. In many cases, when a user enters a search term (whether on a web site or an Internet-based or software-based computing application), the entered term will match a category or synonym listed within the application's Internet Index. At other times, the entered term will match a site name or synonym listed within the application's listing of contained web sites (“Site Index”). Operation in the former case is described above. In the latter case, if a user clicks on a presented site name, that site's home page or other interior page will open directly in the Companion Browser, without the user's having to go through the intermediate step of opening and browsing through a Dataset.

In some cases, however, there will be no matches between the search term and items listed in either the Internet Index or Site Index. In such cases, the user will be presented with a selection of “meta-categories,” including a variety of sites related to a particular subject area, that the user may employ in order to conduct a keyword search similar to that performed on conventional search engines. Should the user elect to search through one of these meta-categories by clicking on it, a special Meta-Category Search Dataset opens in the Internet Remote, and the user's search term is displayed in a subsidiary search box that is located, in one embodiment, adjacent to the Dataset Panel. Like the system's other Datasets, a Meta-Category Search Dataset includes a listing of web sites that are arranged in some combination of subcategorical and alphabetical order. If a user clicks on one of these site names, that site opens in the Companion Browser. What takes place, however, is that the search term is automatically passed to the native search function (if present) contained within the selected site, and a search is automatically performed for the displayed search term within that site. The results that are subsequently displayed within the Companion Browser are those that would have been displayed had the user executed the same search directly from that site's native search box. Subsequently, if the user clicks on another site within the Meta-Category Search Dataset, the same kind of search is performed on that site (employing that site's native search function), and the results are displayed similarly in the Companion Browser.

Note that the listing of sites within the Meta-Category Search Dataset, in the preferred embodiment of the invention, is presented in a subcategorical and alphabetical order that is invariant, for a given instance of the IWSD, to the term being searched. In another embodiment of the invention, however, the sites within the Meta-Category Search Dataset are ordered in a fashion related to the density of the search results within the sites contained within that Dataset—for instance, the sites may be displayed in the order representing the number of results for the given search term found within the respective sites. In still another embodiment of the invention, the search may be performed simultaneously against all web sites contained within a given Meta-Category Search Dataset, and the results displayed in some ordered fashion according to individual pages within those sites rather than according to search density within the sites themselves.
Use Case 4. Search from a family of drop-down lists. In one embodiment of the invention, the system's web interface contains a number of callable drop-down lists that contain pre-built lists of web sites and categories. Some of these lists are topically named; some are alphabetical; and some are substantively related to the content of a given web page within the system. When the user selects a web site listed within a drop-down list, the referenced site opens in the Companion Browser window, and the Internet Remote opens to the Dataset within which that site is contained or with which it has been associated in the IWSD. When the user selects a topical category from a drop-down list, that category's uniquely associated Dataset is called, and that Dataset opens within the Internet Remote. Simultaneously, the web page associated with that Dataset opens in the Companion Browser, replacing that window's current contents. The effect is the same as if a category had been chosen from the Categorical Search Results produced by a search from a search box as described previously.

In another embodiment of the invention, one or more drop-down lists (which could be arranged, for example, in a nested or hierarchical fashion) is contained within the Internet remote. For hierarchical arrangements, selecting a category within a drop-down list may cause a listing of other categories to be displayed within the context of the Internet Remote. For non-hierarchical arrangements or at the end of an hierarchical chain, selecting a category from within a drop-down list causes that category's corresponding Dataset to be displayed within the Internet Remote's Dataset Panel. The Dataset Panel thereafter operates in the same manner as above. Users subsequently can use the family of drop-down lists to navigate to other categories within the IWSD, even potentially to all of the categories contained within the IWSD.

Other Features and Advantages of the Present Invention

Other features of the various embodiments of the present invention include, but are not limited to the following:
Persistent and consistent navigation. In one embodiment, the navigation is always present and viewable (persistence) and is always in the same style and location (consistency). Indeed, the Internet Remote and companion browser format of the invention allows for search results, information, shopping, and other content categories, embedded lists, and most advertisements to be persistently viewable during the entire time that one is browsing or exploring the search results—something that no other web-based search application makes possible.
Minimal content depth. Content within the present invention in its various embodiments is strictly limited so that never more than one to three clicks is necessary to reach the system's actual web links, greatly speeding site browsing.
At-a-glance viewing. In certain embodiments, all content is visible at a glance at each navigational level, either directly or with minimal scrolling, in certain instances with subcategory headings and class designations, all of which greatly assist in the assimilation and cognitive parsing of the content.
No scrolling. In one embodiment of the invention, at standard monitor screen sizes (1024×768 pixels) or greater, the need for scrolling of the main system interface is eliminated (generally, the only scrolling that exists within this embodiment takes place within the bounds of the various navigational palettes and lists).
Advertising prominence. One embodiment of the invention offers advertisers a prominent position adjacent to the system's listing of web sites within the given information, shopping, and other content categories, and advertisers are able to display large static, animated, or video ads, as well as text-based ads, all integrated within the system's application interface and keyed to the category being viewed, to the search term being searched, and, in some embodiments, to the preferred Zip Code of the user or other denominator of the user's geographical location

Thus, as is evident from the above description, the present invention in its various embodiments is a significant improvement over current Internet browsing and search systems. The advantages can be realized by end-users, by those that private-label the system, and by those that advertise on the system. Other advantages include, but are not limited to, the following:
Streamlined navigation. As noted, because of strict limits on the number of subject categories and topic areas, the present invention can greatly streamline web browsing. Topic areas within a category can be visible at a glance within a single pane. Once a user has selected a topic, all indexed sites within that topic area can be made visible at a glance with the use of a convenient scroll bar, and only a single mouse click is needed to review the selected web sites.
Relevance of content. Web links in the present invention can be carefully chosen to include all of the most important topic areas and all of the web sites (particularly the name-brand web sites) within those topic areas that a typical web user would expect to see. Less relevant or lower quality web sites can be omitted. The result: web users can quickly navigate, in television remote-control-like fashion, to all of the web sites they most likely would want to see without being burdened by a deluge of less relevant sites.
Quality of search results. Because the integrated search boxes search only among the indexed sites with a particular data category or grouping of categories, searches within the invention can yield considerably more focused, high-quality search results than achievable via traditional search engines (i.e., the invention can limit searches to only among the most useful sites and not among the less relevant sites).
Integrity of content. Unlike traditional search engines, where placement is a result in large part of “gaming” techniques like search engine optimization and inbound link generation that have nothing to do with the web site's intrinsic quality, and unlike pay-for-position search engines, which sacrifice quality, integrity, and usefulness in order to generate revenue, the present invention's web site listings can be based on the intrinsic value and relevance of indexed sites. Advertising and any paid-search results are clearly segmented from the indexed search results, and are presented in clearly delineated sections of the system's interface.
Advertising power. The present invention can integrate visual, animated, and video advertising directly into the system's graphical interface, clearly associated with specific information, shopping, and other content categories, and places such advertising in a highly prominent position, thereby delivering visual and contextual advertising power that other Internet search engines typically do not match. The invention is also capable of displaying keyword-based animated and video advertisements directly within the context of the system's interface. Advertising can take place within the context of very granular topic areas, significantly increasing the value of the ad placement, as the ads capture users' attention at the moment of their greatest interest in a wide variety of specific topics. In addition, City- and Zip Code-based tagging along with IP identification make it possible to secure and display highly localized advertisements and other content in the thousands of topical categories included within the system's index. Locally based advertisements and content also can be keyed to searches in the U.S. and World Cities categories indexed within the system.
   Variations of the Present Invention

It should be understood, as noted above in a number of instances, that the above-described embodiments of the present invention are only illustrative of the application of the basic principles of the invention. Numerous modifications and alternative arrangements may be devised, including those described above, by those skilled in the art without departing from the spirit and scope of the present invention. Therefore, the above descriptions should not be taken as limiting the scope of the invention that is defined by the metes and bounds of the appended claims along with their full scope of equivalents.

What is claimed is:

1. An Internet-based search, navigation, and web-page and web-site display system, comprising:
a) an electronic database, wherein the database includes one or more topical categories of information and wherein the categories are further divided into datasets consisting of one or more pre-selected web locations, which in some cases are further subdivided into one or more subcategories of information;
b) an optional collection of datasets so defined, contained within an electronic database, wherein the pre-selected web locations are organized within the datasets topically, alphabetically, by relevance, according to some other organizing methodology, or in some combination thereof;
c) one or more optional indexes to the datasets contained within an electronic database, in which keyword terms are associated with one or more datasets, portions of datasets, collections of datasets, or some combination thereof;
d) a navigation palette functioning as an Internet remote that operates in communication with the electronic database, wherein the Internet remote includes one or more of the following:
i) a title bar;
ii) one or more advertising windows;
iii) a channel selector;
iv) an optional navigation palette;
v) a site-link display panel (navigation panel);
vi) an optional set of subcategory bars;
vii) one or more search boxes; and
viii) an optional set of links to web sites or web pages within web sites;
e) one or more optional launching web pages, advertisements, web page links, email links, and/or computer icons (hereafter, “launching page”) containing one or more dataset links, dataset keywords, advertisements, web-site referral, affiliate, or associate program links, geographic maps, graphic illustrations, search boxes, or some combination thereof, the activation of any of which causes the Internet remote to launch and display its content in a format defined by the electronic database and according to the manner in which the Internet remote was launched and/or the tool by which it was launched.
f) a companion browser that is capable of displaying a web site or web page corresponding to a link presented or a search term entered within the Internet remote and/or alaunching page when the user activates the link or enters the search term.

2. The system of claim 1, wherein the web locations so referred are web sites, web pages within web sites, or some combination thereof.

3. The system of claim 1, wherein the web locations are web-based video programs, video channels, web sites containing video content, or some combination thereof.

4. The system of claim 1, wherein the web locations are web sites internal to a private, educational, nonprofit, or government entity (“intranets”), web pages within web sites internal to a private, educational, nonprofit, or government entity, or some combination thereof.

5. The system of claim 1, wherein the web locations are web sites, email messages, weblogs, other web content, or some combination thereof created and posted to the Internet by a private individual or company.

6. The system of claim 1, wherein the web locations are links to documents, files, or other materials on the user's computer hard drive, on a remote computer, or on a computer network.

7. The system of claim 1, wherein the web locations are web sites, web pages within web sites, or some combination thereof, in which the web links so presented and displayed are nominated or posted by users of the system.

8. The system of claim 1, wherein the web locations include, are embedded with, and/or are appended with links or reference codes or similar identifiers to web-based referral, affiliate, or associate programs.

9. The system of claim 1, wherein the Internet remote consists of the defined elements in claim 1 displayed within a conventional or modified web browser.

10. The system of claim 1, wherein the Internet remote consists of the defined elements in claim 1 displayed within a web-based computer program that operates on a server accessed by the user over the Internet.

11. The system of claim 1, wherein the Internet remote consists of the defined elements in claim 1 displayed within a web-based computer program that is downloaded to and installed on the user's computer.

12. The system of claim 1, wherein one or more search box within the Internet remote and/or a launching page is capable of receiving either search terms or URLs.

13. The system of claim 12, wherein the Internet remote displays a dataset, list of datasets, keywords or index terms associated with a dataset, individual web sites, individual web pages within web sites, referral, affiliate, or associate program links, or some combination thereof, in response to the user's entering of a search term or URL into one or more search boxes within the Internet remote and/or a launching page.

14. The system of claim 12, wherein the companion browser displays a web site, a web page within a web site, a combination of web sites or web pages, referral, affiliate, or associate program links, other web content, or some combination therefore in response to the user's entering of a search term or URL into one or more search boxes within the Internet remote and/or a launching page or in response to the user's selection of a category, channel, subcategory, advertisement, or referral, affiliate, or associate program link within the Internet remote and/or a launching page.

15. The system of claim 12, wherein the Internet remote displays web sites, web pages, referral, affiliate, or associate program links, other web content, or some combination thereof in accordance with some measure of relevance to a search term or URL entered by the user into one or more search boxes within the Internet remote and/or a launching page.

16. The system of claim 12, wherein the Internet remote passes a search term entered into one or more search boxes within the Internet remote and/or a launching page to one or more web sites, web pages within web sites, referral, affiliate, or associate program link, or some combination thereof, such that each selected web site or web page displays the search results for that web site or web page within the companion browser.

17. The system of claim 1, wherein the advertising window within the Internet remote is capable of displaying advertisement types, informative content, educational content, news content, or other web content selected from the group consisting of: graphics, text, web links, animated graphics, flash graphics, and video.

18. The system of claim 17, wherein the content displayed within the advertising window is contained within or referenced by an electronic database.

19. The system of claim 17, wherein the content displayed within the advertising window is displayed according to the search term the user has entered within the Internet remote and/or a launching page, the category, channel, subcategory, advertisement, web site, web page, or referral, affiliate, or associate program link that the user has activated within the Internet remote and/or a launching page, or some combination thereof.

20. The system of claim 17, wherein the companion browser displays a web site, web page within a web site, collection of web sites or web pages, a referral, affiliate, or associate program link, other web content, or some combination thereof in the companion browser according to the search term the user has entered within the Internet remote and/or a launching page, the category, channel, subcategory, advertisement, web site, web page, or referral, affiliate, or associate program link that the user has activated within the Internet remote and/or a launching page, or some combination thereof. Respectfully, submitted, this 20^{th} day of Jun., 2007.
